(19) United States
(12) Patent Application Publication
(10) Pub. No.: US 2007/0225995 A1
(43) Pub. Date: Sep. 27, 2007

(54) Method and Security Modules for an Incident Deployment and Response System for Facilitating Access to Private Civil Security Resources

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/556,520

(22) Filed: Nov. 3, 2006

Related U.S. Application Data
(63) Continuation-in-part of application No. 11/384,037, filed on Mar. 17, 2006.
Application No. 11/384,037 is a continuation-in-part of application No. 11/394,350, filed on Mar. 30, 2006.
Application No. 11/394,350 is a continuation-in-part of application No. 11/279,333, filed on Apr. 11, 2006.
Application No. 11/279,333 is a continuation-in-part of application No. 11/379,929, filed on Apr. 24, 2006.
Application No. 11/379,929 is a continuation-in-part of application No. 11/381,247, filed on May 2, 2006.
Application No. 11/381,247 is a continuation-in-part of application No. 11/381,257, filed on May 2, 2006.
Application No. 11/381,257 is a continuation-in-part of application No. 11/381,265, filed on May 2, 2006.
Application No. 11/381,265 is a continuation-in-part of application No. 11/381,277, filed on May 2, 2006.
Application No. 11/381,277 is a continuation-in-part of application No. 11/383,022, filed on May 12, 2006.
Application No. 11/383,022 is a continuation-in-part of application No. 11/420,594, filed on May 26, 2006.
Application No. 11/420,594 is a continuation-in-part of application No. 11/421,694, filed on Jun. 1, 2006.
Application No. 11/421,694 is a continuation-in-part of application No. 11/423,594, filed on Jun. 12, 2006.
Application No. 11/423,594 is a continuation-in-part of application No. 11/425,043, filed on Jun. 19, 2006.
Application No. 11/425,043 is a continuation-in-part of application No. 11/426,231, filed on Jun. 23, 2006.
Application No. 11/426,231 is a continuation-in-part of application No. 11/456,472, filed on Jul. 10, 2006.
Application No. 11/456,472 is a continuation-in-part of application No. 11/461,605, filed on Aug. 1, 2006.
Application No. 11/461,605 is a continuation-in-part of application No. 11/461,624, filed on Aug. 1, 2006.
Application No. 11/461,624 is a continuation-in-part of application No. 11/462,795, filed on Aug. 7, 2006.
Application No. 11/462,795 is a continuation-in-part of application No. 11/462,845, filed on Aug. 7, 2006.
Application No. 11/462,845 is a continuation-in-part of application No. 11/464,751, filed on Aug. 15, 2006.
Application No. 11/464,751 is a continuation-in-part of application No. 11/464,764, filed on Aug. 15, 2006.
Application No. 11/464,764 is a continuation-in-part of application No. 11/464,775, filed on Aug. 15, 2006.
Application No. 11/464,775 is a continuation-in-part of application No. 11/464,788, filed on Aug. 15, 2006.
Application No. 11/464,788 is a continuation-in-part of application No. 11/464,799, filed on Aug. 15, 2006.
Application No. 11/464,799 is a continuation-in-part of application No. 11/465,063, filed on Aug. 16, 2006.
Application No. 11/465,063 is a continuation-in-part of application No. 11/466,727, filed on Aug. 23, 2006.
Application No. 11/466,727 is a continuation-in-part of application No. 11/466,953, filed on Aug. 24, 2006.
Application No. 11/466,953 is a continuation-in-part of application No. 11/470,156, filed on Sep. 5, 2006.
Application No. 11/470,156 is a continuation-in-part of application No. 11/531,651, filed on Sep. 13, 2006.
Application No. 11/531,651 is a continuation-in-part of application No. 11/532,461, filed on Sep. 15, 2006.
Application No. 11/532,461 is a continuation-in-part of application No. 11/535,021, filed on Sep. 25, 2006.
Application No. 11/535,021 is a continuation-in-part of application No. 11/535,282, filed on Sep. 26, 2006.
Application No. 11/535,282 is a continuation-in-part of application No. 11/537,469, filed on Sep. 29, 2006.
Application No. 11/537,469 is a continuation-in-part of application No. 11/539,798, filed on Oct. 9, 2006.
Application No. 11/539,798 is a continuation-in-part of application No. 11/539,861, filed on Oct. 9, 2006.
Application No. 11/539,861 is a continuation-in-part of application No. 11/548,191, filed on Oct. 10, 2006.
Application No. 11/548,191 is a continuation-in-part of application No. 11/549,874, filed on Oct. 16, 2006.
Application No. 11/549,874 is a continuation-in-part of application No. 11/550,594, filed on Oct. 18, 2006.
Application No. 11/550,594 is a continuation-in-part of application No. 11/551,083, filed on Oct. 19, 2006.
Application No. 11/551,083 is a continuation-in-part of application No. 11/554,452, filed on Oct. 30, 2006.
Application No. 11/554,452 is a continuation-in-part of application No. 11/555,589, filed on Nov. 1, 2006.
Application No. 11/555,589 is a continuation-in-part of application No. 11/555,896, filed on Nov. 2, 2006.
(60) Provisional application No. 60/820,628, filed on Jul. 28, 2006.
(60) Provisional application No. 60/823,806, filed on Aug. 29, 2006.
(60) Provisional application No. 60/825,524, filed on Sep. 13, 2006.
(60) Provisional application No. 60/825,976, filed on Sep. 18, 2006.
(60) Provisional application No. 60/826,491, filed on Sep. 21, 2006.
(60) Provisional application No. 60/827,591, filed on Sep. 29, 2006.
(60) Provisional application No. 60/827,820, filed on Oct. 2, 2006.
(60) Provisional application No. 60/827,828, filed on Oct. 2, 2006.
(60) Provisional application No. 60/828,341, filed on Oct. 5, 2006.
(60) Provisional application No. 60/828,342, filed on Oct. 5, 2006.
(60) Provisional application No. 60/829,447, filed on Oct. 13, 2006.
(60) Provisional application No. 60/829,779, filed on Oct. 17, 2006.
(60) Provisional application No. 60/862,398, filed on Oct. 20, 2006.
(60) Provisional application No. 60/863,469, filed on Oct. 30, 2006.
(60) Provisional application No. 60/863,481, filed on Oct. 30, 2006.

(51) Int. Cl. G06Q 10/00; G06Q 30/00

(52) U.S. Cl. 705/1

(57) ABSTRACT

A plurality of private civil security resources comprise, at least in part, civil security provisions, civil security facilities, and civil security provisions. Authorized beneficiaries are then provided with consideration-based access to this plurality of private civil security resources. A management system is used to manage at least the private civil security resources. Profiles of the authorized beneficiaries are at least electronically isolated from access by the management system at least while the management system is performing non-profile required tasks.

### RELATED APPLICATIONS

This application claims the benefit of the filing date of U.S. provisional application Nos. 60/820,628 filed on Jul. 28, 2006, 60/823,806 filed on Aug. 29, 2006, 60/825,524 filed on Sep. 13, 2006, 60/825,976 filed on Sep. 18, 2006, 60/826,491 filed on Sep. 29, 2006, 60/827,591 filed on Sep. 29, 2006, 60/827,820 filed on Oct. 2, 2006, 60/827,828 filed on Oct. 2, 2006, 60/828,341 filed on Oct. 5, 2006, 60/828,342 filed on Oct. 5, 2006, 60/829,447 filed on Oct. 13, 2006, 60/829,779 filed on Oct. 17, 2006, 60/862,398 filed on Oct. 20, 2006, 60/862,718 filed on Oct. 24, 2006, 60/863,469 filed on Oct. 30, 2006, 60/863,481 filed on Oct. 30, 2006, which are hereby incorporated in their entirety herein.

This comprises a continuation-in-part of each of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265;

SUBSCRIPTION-BASED CATASTROPHE-TRIGGERED RESCUE SERVICES FACILITATION METHOD AND APPARATUS as filed on May 2, 2006 and having application Ser. No. 11/381,277;

DOCUMENT-BASED CIVILLY-CATASTROPHIC EVENT PERSONAL ACTION GUIDE FACILITATION METHOD as filed on May 12, 2006 and having application Ser. No. 11/383,022;

RESCUE CONTAINER METHOD AND APPARATUS as filed on May 26, 2006 and having application Ser. No. 11/420,594;

PURCHASE OPTION-BASED EMERGENCY SUPPLIES PROVISIONING METHOD as filed on Jun. 1, 2006 and having application Ser. No. 11/421,694;

SUBSCRIPTION-BASED PRE-PROVISIONED TOWABLE UNIT FACILITATION METHOD as filed on Jun. 12, 2006 and having application Ser. No. 11/423,594;

RADIATION-BLOCKING BLADDER APPARATUS AND METHOD as filed on Jun. 19, 2006 and having application Ser. No. 11/425,043;

PRIVATE CIVIL DEFENSE-THEMED TELEVISION BROADCASTING METHOD as filed on Jun. 23, 2006 and having application Ser. No. 11/426,231;

EMERGENCY SUPPLIES PRE-POSITIONING AND ACCESS CONTROL METHOD as filed on Jul. 10, 2006 and having application Ser. No. 11/456,472;

PRIVATE CIVIL DEFENSE-THEMED BROADCASTING METHOD as filed on Aug. 1, 2006 and having application Ser. No. 11/461,605;

METHOD OF PROVIDING VARIABLE SUBSCRIPTION-BASED ACCESS TO AN EMERGENCY SHELTER as filed on Aug. 1, 2006 and having application Ser. No. 11/461,624;

SUBSCRIPTION-BASED INTERMEDIATE SHORT-TERM EMERGENCY SHELTER METHOD as filed on Aug. 7, 2006 and having application Ser. No. 11/462,795;

SUBSCRIPTION-BASED CATASTROPHE-TRIGGERED RESCUE SERVICES FACILITATION METHOD USING WIRELESS LOCATION INFORMATION as filed on Aug. 7, 2006 and having application Ser. No. 11/462,845;

PRIVATELY PROVISIONED SURVIVAL SUPPLIES DELIVERY METHOD as filed on Aug. 15, 2006 and having application Ser. No. 11/464,751;

PRIVATELY PROVISIONED SURVIVAL SUPPLIES SUB-UNIT-BASED DELIVERY METHOD as filed on Aug. 15, 2006 and having application Ser. No. 11/464,764;

PRIVATELY PROVISIONED SURVIVAL SUPPLIES ACQUISITION METHOD as filed on Aug. 15, 2006 and having application Ser. No. 11/464,775;

PRIVATELY PROVISIONED SURVIVAL SUPPLIES CONTENT ACQUISITION METHOD as filed on Aug. 15, 2006 and having application Ser. No. 11/464,788;

METHOD TO PRIVATELY PROVISION SURVIVAL SUPPLIES THAT INCLUDE THIRD PARTY ITEMS as filed on Aug. 15, 2006 and having application Ser. No. 11/464,799;

WASTE DISPOSAL DEVICE as filed on Aug. 16, 2006 and having application Ser. No. 11/465,063;

SUBSCRIPTION-BASED PRIVATE CIVIL SECURITY RESOURCE CUSTOMIZATION METHOD as filed on Aug. 23, 2006 and having application Ser. No. 11/466,727;

PREMIUM-BASED PRIVATE CIVIL SECURITY POLICY METHODS as filed on Aug. 24, 2006 and having application Ser. No. 11/466,953;

SUBSCRIPTION-BASED MOBILE SHELTER METHOD as filed on Sep. 5, 2006 and having application Ser. No. 11/470,156;

METHOD OF PROVIDING A FLOATING LIFE-SUSTAINING FACILITY as filed on Sep. 13, 2006 and having application Ser. No. 11/531,651;

PRIVATELY PROVISIONED SUB-UNIT-BASED SURVIVAL SUPPLIES PROVISIONING METHOD as filed on Sep. 15, 2006 and having application Ser. No. 11/532,461;

PRIVATELY PROVISIONED INTERLOCKING SUB-UNIT-BASED SURVIVAL SUPPLIES PROVISIONING METHOD as filed on Sep. 25, 2006 and having application Ser. No. 11/535,021;

RESOURCE CONTAINER AND POSITIONING METHOD AND APPARATUS as filed on Sep. 26, 2006 and having application Ser. No. 11/535,282;

PUBLICLY-FUNDED PRIVATELY FACILITATED ACCESS TO SURVIVAL RESOURCES METHOD as filed on Sep. 29, 2006 and having application Ser. No. 11/537,469;

ELECTRICITY PROVIDING PRIVATELY PROVISIONED SUBSCRIPTION-BASED SURVIVAL SUPPLY UNIT METHOD AND APPARATUS as filed on Oct. 9, 2006 and having application Ser. No. 11/539,798;

PREMIUM-BASED CIVILLY-CATASTROPHIC EVENT THREAT ASSESSMENT as filed on Oct. 9, 2006 and having application Ser. No. 11/539,861;

PRIVATELY MANAGED ENTERTAINMENT AND RECREATION SUPPLIES PROVISIONING METHOD as filed on Oct. 10, 2006 and having application Ser. No. 11/548,191;

METHOD TO FACILITATE PROVIDING ACCESS TO A PLURALITY OF PRIVATE CIVIL SECURITY RESOURCE as filed on Oct. 16, 2006 and having application Ser. No. 11/549,874;

METHOD OF PROVIDING BEARER CERTIFICATES FOR PRIVATE CIVIL SECURITY BENEFITS as filed on Oct. 18, 2006 and having application Ser. No. 11/550,594;

METHOD FOR CIVILLY-CATASTROPHIC EVENT-BASED TRANSPORT SERVICE AND VEHICLES THEREFOR as filed on Oct. 19, 2006 and having application Ser. No. 11/551,083;

METHOD FOR PROVIDING PRIVATE CIVIL SECURITY SERVICES BUNDLED WITH SECOND PARTY PRODUCTS as filed on Oct. 30, 2006 and having application Ser. No. 11/554,452;

SYSTEM AND METHOD FOR A PRIVATE CIVIL SECURITY LOYALTY REWARD PROGRAM as filed on Nov. 1, 2006 and having application Ser. No. 11/555,589;

SUBSCRIPTION BASED SHUTTLE METHOD as filed on Nov. 2, 2006 and having application Ser. No. 11/555/896;

the contents of each of which are fully incorporated herein by this reference.

### TECHNICAL FIELD

This invention relates generally to maintaining the privacy of recipients of private civil security benefits.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable goods from source to consumer;

communications infrastructure such as telephones, television, radio, and the Internet that facilitate the inexpensive and rapid sharing of news, advice, information, and entertainment; and

the totality of civil services such as police services, fire fighting services, medical services, and so forth that facilitate a sufficient degree of order and predictability to, in turn, permit the complex series of inter-related interactions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general require many things to all operate, more or less, correctly. To put it another way, a serious disruption to any significant element of civilized infrastructure can produce catastrophic results for a broad swatch of a given civil community. Any number of natural and/or non-naturally-caused events can sufficiently disrupt society's infrastructure and ability to provide one or more life-sustaining resources such as hydration, nutrition, shelter, and the like.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a civilly-catastrophic event occurs.

Such insights, of course, are not particularly new. Civil preparedness shortcomings occasionally attract public attention and niche marketing opportunities exist with respect to provisioning the needs of so-called survivalists. Indeed, there are those who spend a considerable amount of their time and monetary resources attempting to ready themselves to personally survive a civilly-catastrophic event. Therein, however, lies something of a conundrum.

On the one hand, modern governments typically do little to proactively ensure the bulk survival (let alone the comfort) of their citizens in the face of most civilly-catastrophic events. On the other hand, attempting to take responsible actions to reasonably ensure one's own safety and security can become, in and of itself, nearly a full-time avocation and leave little time to actually enjoy the conveniences and opportunities of modern life. Such individual actions may even be frowned upon by the greater part of society which has grown accustomed and falsely secure with existing efficient just-in-time delivery systems that provide the illusion of plenty while undercutting the perception of risk.

As a result, many (if not most) individuals and their families are largely bereft of access to survival resources that they will need should a civilly-catastrophic event befall them. This shortcoming tends to be relatively comprehensive; most people have ready access to neither a sufficient selection of survival supplies nor a sufficient quantity. For people who do have a store of supplies set aside against such an eventuality, it can be a considerable burden to maintain and ensure the freshness, vitality, and usability of those supplies. At the same time, the same civilly-catastrophic event that occasions their need for supplies will also likely disrupt relevant supply chains enough to cause a partial or complete shortage of supplies at their local merchants. The unfortunate net result is a relatively near term severe need for a variety of survival supplies that will often go unmet for lengthy periods of time.

Such persons are also largely without many options when faced with civilly-catastrophic conditions that create a concurrent need for shelter, evacuation, and/or rescue. For example, in many cases, the only available shelter comprises a public facility such as a school, auditorium, or sports venue on the one hand or ad hoc accommodations obtained at a hotel or via a charity or one's own social network. In some cases, such options may be adequate. In many other cases, however, such options quickly prove inadequate or even dangerous in and of themselves.

### BRIEF DESCRIPTION OF THE DRAWINGS

The above needs are at least partially met through provision of the method and security modules for an incident deployment and response system for facilitating access to private civil security resources described in the following detailed description, particularly when studied in conjunction with the drawings, wherein:

FIG. 1 comprises a flow diagram as configured in accordance with various embodiments of the invention;

FIG. 2 comprises a schematic block diagram view as configured in accordance with various embodiments of the invention;

FIG. 3 comprises a schematic block diagram as configured in accordance with various embodiments of the invention;

FIG. 4 comprises a schematic block diagram as configured in accordance with various embodiments of the invention;

FIG. 5 comprises a flow diagram as configured in accordance with various embodiments of the invention; and

FIG. 6 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a plurality of private civil security resources are provided. These private civil security resources comprise, at least in part, civil security provisions, civil security facilities, and civil security services. Authorized beneficiaries are then provided with consideration-based access to this plurality of private civil security resources. A management system is provided to manage the private civil security resources. The management system uses profiles of the authorized beneficiaries to determine the needs and preferences of the authorized beneficiaries with respect to the private civil security resources. The profiles, however, are at least electronically isolated from the management system at least while the management system is performing non-profile required tasks in order to provide security and privacy for the authorized beneficiaries. These and some of the many other facets of the management system are described below.

In order to better secure the privacy of authorized beneficiaries, one feature of the management system is a security module that is, or includes, a privacy module that holds the profiles of the authorized beneficiaries. By one approach, the privacy module is selectively detachable from the management system. Otherwise, a data security module may be used to control the access to the privacy module when it is accessible. The data security module also provides access to the profiles based on a security clearance level of a user or personnel of at least one provider of the private civil security resources. The security module is also explained in detail below.

As to the private civil security resources, the private civil security provisions can comprise various life-sustaining resources as pertain to various categories of life's necessities, including, for example, breathable air, water, food, and protective clothing. Deployable shelters can also be included if desired. Non-civil security resources (such as, but not limited to, luxury items) can also be provided if desired to supplement such staples.

The civil security facilities can comprise various facilities as have application with respect to protecting such authorized beneficiaries from the effects (including the aftermath, if any) of a civilly-catastrophic event and other dangerous or unpleasant environmental or external influences and forces. These facilities can include, for example, such things as civil security shelters (including both short term and longer term facilities), transportation rally points, trans-shipment facilities and/or distribution facilities for civil security provisions, medical services facilities, training facilities, and so forth.

The civil security services can similarly comprise any of a wide variety of services as have application with respect to protecting such authorized beneficiaries. Exemplary services include, but are not limited to, civil security information services (including information that is both generally and specifically appropriate for individual ones of the authorized beneficiaries), transportation services, rescue services, and so forth.

So configured, authorized beneficiaries will have concrete, predictable access to various categories of privately supplied civil security resources while being reasonably assured that their private profile data used, or that may be used, to plan deployment of the resources should be secured from unauthorized access and use. These steps are readily facilitated without dependency upon (and perhaps even in spite of) governmental oversight, participation, or control. The particular resources provided can vary with the needs and requirements of the authorized beneficiaries. Importantly, via these teachings individuals can benefit from a greatly increased opportunity to bring a considerably improved measure of security into their lives, knowing that, should a civilly-catastrophic event indeed be visited upon them, they will have extraordinary and reliable access to privately facilitated civil security resources.

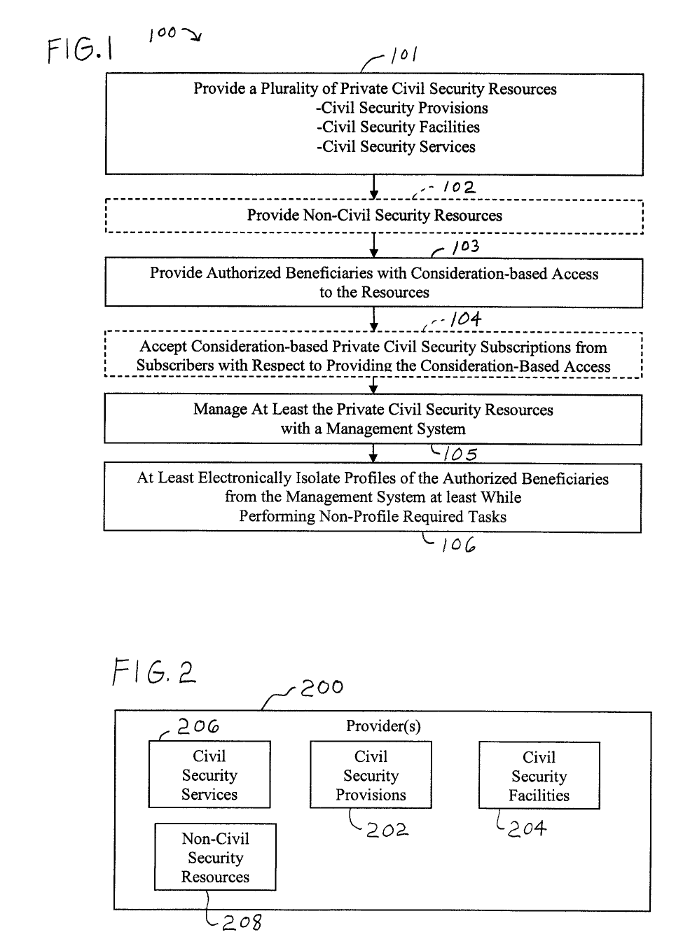

These and other benefits may become clearer upon making a thorough review and study of the following detailed description. Referring now to the drawings, and in particular to FIGS. 1-2, a corresponding process 100 provides 101 a plurality of private civil security resources. As used herein, “private” will be understood to refer to the opposite of public ownership or control (as exemplified by governmental or ecclesiastical ownership or control) but can include such things as ownership or control via publicly traded ownership (via, for example, publicly traded stock or the like), ownership or control via a not-for-profit entity, or the like.

The plurality of private civil security resources can vary to some degree with respect to category and kind of resource. By one approach, however, such resources will comprise, at least in part, civil security provisions 202, civil security facilities 204, and civil security services 206. Generally speaking, both the civil security provisions and civil security facilities are physical components rather than virtual components or products of the intellect. For example, the civil security provisions will typically comprise physical support and/or protection of one kind or another. Similarly, the civil security facilities will also typically comprise physical assets such as, but not limited to, physical shelters that provide real, substantive physical protection from physical threats to human life. Additional details in this regard are provided below. Also as described in more detail below, however, the civil security services can comprise either physical, real world services or virtual-content services.

These civil security provisions can comprise, for example, a plurality of life-sustaining resources as pertain to a plurality of differing categories of life's necessities. Examples in this regard include, but are not limited to, such elemental staples as water or other fluids (which can comprise water in a pure or impure state and/or other water-based palatable fluids), food (which can comprise a wide variety of raw to highly processed food, nutritional supplements, and so forth), protective clothing (where “protective” will be understood to refer to protection against one or more potentially hazardous environmental influences such as temperature extremes, precipitation, high velocity winds, and the like but not to matters of fashion, social comment, or the like).

These civil security provisions 202 can further optionally include such components as breathable air (which may comprise, for example, a fresh air supply, an oxygen supply (including but not limited to oxygen generators such as, but not limited to, chemical oxygen generators that often produce oxygen as part of a corresponding exothermic reaction) that can serve as a source of oxygen to mix with other atmospheric components, and/or personal or area air filters that serve to remove harmful airborne contaminants from the air prior to being inhaled by an authorized beneficiary), deployable shelters (where “deployable” will be understood as referring to portable shelters such as tents, canopies, inflatable structures, and the like), and other items as may be appropriate to meet the needs of a given application setting.

By one approach, these civil security provisions can be so provided in an aggregated form. Such might be the case, for example, when accumulating such material at a warehouse or the like. These teachings will also accommodate, however, forming such civil security provisions into corresponding units of civil security provisions. To illustrate, one such unit of civil security provisions as intended, for example, for a single authorized beneficiary might comprise, at least in part, consumable fluids, food, medical supplies, personal hygiene supplies, and environmental threat abatement supplies (such as, for example, breathing masks, hazardous materials handling garb, and the like).

Such a unit of civil security provisions might comprise, for example, a short term unit that comprises a quantity and variety of civil security supplies that are adequate to sustain life for that one authorized beneficiary for, say, at least three days and no more than, say, about fifteen days. As another illustrative example, such a unit of civil security provisions might comprise a longer term unit that comprises a quantity and variety of civil security supplies that are adequate to sustain life for that authorized beneficiary for, say, at least about thirty days but no more than, say, about one year.

Those skilled in the art will recognize and understand that there are various ways by which such adequacy can be determined, measured, and/or established. For example, by one approach, the adequacy of any food contents can be determined as a function of a particular target caloric intake per person on a per day basis. Similarly, the adequacy of any consumable fluid contents could be determined as a function of a particular target quantity intake per person on a per day basis.

The particular time frames suggested in the above examples are intended only to serve an illustrative purpose and are not to be construed as limitations with respect to the practice of these teachings. Those skilled in the art will also appreciate and understand that such a unit of civil security provisions can comprise a quantity of supplies that are intended to support more than one authorized beneficiary for the given period(s) of time. For example, such a unit might comprise a family unit that contains sufficient contents to adequately sustain life for a family of four authorized beneficiaries.

These teachings will also accommodate providing civil security provisions that differ from one another in ways other than by category or kind. For example, both branded and generic versions (or other differentiators with respect to quality) of a same kind of item can be selectively provided if desired.

Referring again to FIGS. 1-2, the civil security facilities 204 will typically comprise physical assets that tend, categorically, to comprise part of a private civil security infrastructure. Such civil security facilities can therefore comprise, for example:

one or more civil security shelters;

one or more rally points (at which authorized beneficiaries can gather in response to a civilly-catastrophic event in order to receive certain civil security services such as transportation to another civil security facility such as a shelter or at least to a location that is away from a location that presently (or imminently) lacks civil security (due, for example, to a civilly-catastrophic event, its aftermath, or both));

a location where at least some of the authorized beneficiary's civil security provisions are available (such as a metropolitan, local, regional, and/or national distribution facility);

a trans-shipment facility for at least some of the civil security provisions (where, for example, dis-aggregated provisions are brought and then parsed and aggregated into corresponding units of provisions destined for particular recipient authorized beneficiaries);

a medical services facility;

and so forth, to note but a few relevant examples in this regard.

These teachings will readily accommodate a wide variety of civil security shelters. For example, this process 100 can provide for both temporary civil security shelters and longer term civil security shelters. A temporary civil security shelter will be understood to comprise a shelter that is configured and arranged to adequately shelter and sustain human life for a relatively short period of time. For example, such a temporary shelter might prove sufficient in this regard for, say, no more than about ten inhabitants for no more than about one week, ten days, 15 days, and the like. Generally speaking, a temporary shelter such as this is designed and intended to only serve as a temporary refuge from the effects of a civilly-catastrophic event. Should longer term accommodations be necessary in a given instance, the inhabitants of such a temporary shelter will often be better served to move to a longer term civil security shelter.

A long term civil security shelter will be understood to comprise a shelter that is configured and arranged to adequately shelter and sustain human life for a relatively longer period of time. For example, such a temporary shelter might prove sufficient in this regard for, say, no more than about 100 inhabitants for up to about three months, six months, one year, or the like. (Again, such numeric examples serve an illustrative, rather than a limiting, purpose only.)

These teachings will also readily accommodate the provision of a longer term civil security shelter up to and including an indeterminate term civil security shelter that is configured and arranged to adequately shelter and sustain human life for an indeterminately long period of time. A shelter of this type will typically be characterized not only by an ability to protect its inhabitants against the rigors of the local environment and to contain a relatively large and varied supply of provisions, but by an ability to exist and operate in a fully or at least substantially independent manner. This can relate in particular to an ability to create and/or otherwise replace its consumable provisions (by, for example, growing food, creating power, and so forth).

It is also possible for such shelters to differ from one another in other ways. For example, such shelters may differ with respect to the non-survival related amenities that are provided. These differences can relate to categories of amenities (such as educational facilities, workshop facilities, food preparation facilities, communications facilities, entertainment and/or recreational facilities, or the like) and/or to a relative level or perception of quality, comfort, convenience, or the like.

The aforementioned civil security services 206 can comprise any of a relatively wide variety of offerings. Some examples include, but are certainly not limited to:

transportation services (where such transportation services are not ordinary mass or individual transit services but instead represent, for example, services that are designed, scheduled, and deployed to effect transportation of dispossessed persons away from a location that substantially lacks civil security (such as an area afflicted by a civilly-catastrophic event) and/or transportation to the aforementioned civil security facilities);

civil security information (including both civil security information that is generally appropriate for a large number (or all) of the authorized beneficiaries (such as civil security preparedness training or the like) as well as information that is specifically appropriate for individual ones of the authorized beneficiaries (such as personal contingency instructions that are formed and provided to guide specific authorized beneficiaries during a time of need regarding particular actions and behaviors that such specific individuals should take and observe when responding to a civilly-catastrophic event as well as consulting services that assist such individuals with respect to fortifying their relative positions and/or otherwise better protecting themselves against the effects of various civilly-catastrophic events);

communications services, including long distance communication services (including, for example, wireless-based services) that are configured and arranged to provide substantially persistent communication services notwithstanding interaction of the long distance communication service with the effects of a civilly-catastrophic event (which may include, for example, satellite-based communications, quickly deployed wireless base stations (that comprise, for example, mobile terrestrial platforms, aerial platforms, and so forth), and the like);

civil security rescue services to facilitate, for example, retrieving selected authorized beneficiaries from dangerous circumstances that are owing, at least in part, to a substantial lack of civil security (including, for example, immediate threats posed by life-threatening influences such as fire, collapsed buildings, lawless unpoliced individuals, and the like as well as less-immediate threats (such as starvation, dehydration, infection, or the like) that can follow a substantial failure of civil infrastructure;

civil security delivery services to provide for deliveries to authorized beneficiaries or the like of such things as their corresponding civil security provisions, fuel, and so forth;

civil security medical services (including but not limited to both fixed location and mobile services;

civil security physical security services (to provide, for example, physical security (such as guards, fences and other barriers, surveillance equipment, and so forth) for residences, businesses, and other physical property of interest to an authorized beneficiary);

independent utilities facilities installation services (to provide, for example, for the installation of fuel-burning generators, renewable energy-based power generators, propane-based heating plants, and so forth at, for example, the residences and businesses of authorized beneficiaries);

post-civilly-catastrophic event social relationship facilitation services (to facilitate rebuilding social networks, friendships, partnerships, and romantic relationships for the survivors of civilly-catastrophic events);

and so forth, to note but a few relevant examples.

By one approach, the civil security provisions 202, civil security facilities 204, and civil security services are provided by one or more providers 200. A single provider 200 can be integrally involved with designing, providing, maintaining, and offering such civil security resources or can comprise an aggregator of such resources, in whole or in part, as are provided by other sources. Alternatively, a few or many providers 200 may be involved in providing, coordinating, or assisting with one or more of the private civil security resources. The providers 200 may or may not be separate legal entities. Persons skilled in these arts will understand and appreciate that numerous permutations and combinations of these elements as well as other possibilities are available. Such alternatives are well within the scope of these teachings and are rightly considered to comprise a part of this invention.

Referring again to FIG. 1, this process 100 will also optionally provide for the provision 102 of non-civil security resources 208. Such non-civil security resources 208 comprise supplies and items that are not, strictly speaking, necessary to ensure human survival and hence may be viewed as luxuries. Such items can quite literally span the full gamut of available offerings and can include both unique items (such as original works of art) and more commonly available offerings (such as jewelry, pleasure reading materials, audio playback devices, and so forth). Again, differentiation can exist with respect to actual or perceived levels of quality as pertain to such items if desired.

These steps of providing such civil security resources can further comprise maintaining such resources. This can comprise, for example, maintaining the freshness and usability of civil security provisions (by replacing outdated or soon-to-be outdated supplies), replacing an existing resource with a better substitute that becomes available, maintaining present and/or imminent usability of a civil security shelter or transport vehicle, updating civil security-related information to reflect current data and intelligence, vetting and revetting predetermined evacuation and/or transportation routes, educating and training corresponding personnel, and so forth. Such maintenance can be provided, in whole or in part, by the provider of such civil security resources or can be out-sourced if desired.

This process 100 then provides 103 authorized beneficiaries with consideration-based access to the plurality of private civil security resources. There are various ways by which such authorized beneficiaries can be identified. For example, by one approach, such authorized beneficiaries can attain this status as per the terms and conditions of a consideration-based private civil security benefits subscription that is accepted 104 by a provider or providers 200 of the private civil security resources. For example, a given subscription can provide such status for a stipulated one-year period of time for one or more authorized beneficiaries as correspond to that subscription.

By one approach, these subscriptions may be accepted by, for example, a for-profit business. By another approach a not-for-profit business (such as a membership-based-entity) may be the appropriate entity to offer and accept such subscriptions. As used herein, the term “subscription” shall be understood to refer to and encompass a variety of legal mechanisms. Some relevant examples include, but these teachings are not limited to, subscription mechanisms such as:

time-limited rights of access (as where a subscription provides access rights for a specific period of time, such as one year, in exchange for a corresponding series of payments);

event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);

inheritable rights of access (as may occur when the subscription, by its own terms and conditions, provides a right of access that extend past the death of a named subscription beneficiary and further provides for testate and/or intestate transfer to an heir);

rights of access predicated upon a series of periodic payments (as where a subscription provides access rights during, for example, predetermined periods of time on a periodic basis as where a subscriber offers month-by-month payments to gain corresponding month-by-month access rights);

rights of access predicated upon a one-time payment (as may occur when a subscriber makes a single payment to obtain a time-based or event-based duration of access rights or, if desired, when a single payment serves to acquire a one-time-only right of access or a perpetual right of access that may be retained, transferred, inherited, or the like);

ownership-based rights of access (as may occur when the subscription provides for ownership rights with respect to the civil security resources, when the subscription is based upon shareholder-based ownership of the provider of such civil security resources, or the like);

non-transferable rights of access (as may occur when the subscription, by its terms and conditions, prohibits transfer of the right of access to the civil security resources from a first named beneficiary to another);

transferable rights of access (as may occur when the subscription, by its terms and conditions, permits conditional or unconditional transfer of the right of access from a first named beneficiary to another);

membership-based rights of access (as may occur when the subscription, by its terms and conditions, establishes a membership interest with respect to the accorded right of access such as, for example, a club-based membership);

fractionally-based rights of access (as may occur when the subscription, by its terms and conditions, establishes a divided interest by and between multiple subscription beneficiaries with respect to a right to access the civil security resources);

non-ownership based rights of access (as may occur when the subscription, by its terms and conditions, establishes the aforementioned right of access via, for example, a lease, a rental, or borrowing construct);

option-based rights of access (as may occur when the subscription, by its terms and conditions, establishes a right for an authorized beneficiary to later obtain access to some or all such civil security resources upon, for example, paying an additional supplemental amount at that time); and/or

credit-based rights of access (as may occur when a given individual predicates their right to access the civil security resources upon a representation, promise, or other credit-based transaction).

If desired, a plurality of differentiated subscription opportunities can be offered in this regard. This plurality of differentiated subscription opportunities can correspond, for example, to providing access to differing selections and/or quantities of the civil security resources. As but one very simple illustration in this regard, such subscription opportunities can differ from one another at least with respect to cost. This, in turn, provides subscriber choice with respect to selecting a particular subscription that best meets their specific needs and/or budget limitations.

These teachings also readily encompass the notion of a given subscriber providing such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist. For example, a bearer certificate (or its legal or functional equivalent, such as a gift card) could serve to identify any individual who produces and bears that certificate as an authorized beneficiary.

By one approach, such access can be provided at the whim and convenience of the authorized beneficiaries. If desired, however, such access can be further conditioned in appropriate ways. For example, for many purposes and certainly as pertains to many of the civil security resources it may by appropriate to ordinarily limit such access to situations where such access is triggered, at least in part, by a civilly-catastrophic event having occurred or being likely imminent. Such access may be predicated, if desired, upon a requirement that the civilly-catastrophic event be one that persists in substantial form for more than a predetermined period of time (such as one hour, one day, one week, and so forth) or that causes at least a predetermined amount or degree of infrastructure impairment or other measurable impact of choice (such as a particular level or degree of harm, interference, or negative impact upon a given minimum number of people). In addition, or in lieu thereof, such access may be predicated, if desired, upon a requirement of a particular level of objectivity or subjectively ascertained likelihood that a particular category or kind of civilly-catastrophic event will occur within a particular period of time.

As used herein, “civilly-catastrophic event” will be understood to refer to an event that substantially and materially disrupts a society's local, regional, and/or national infrastructure and ability to provide in ordinary course for at least one life-sustaining resource. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation (or worsening) of that interruption.

A civilly-catastrophic event can be occasioned by any of a wide variety of natural and/or non-naturally-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme space-based events (such as collisions with comets, large asteroids, and so forth, extreme solar flares, and the like), extreme environmental events (such as widespread uncontrolled fire or the like), and global or regional pandemics, to note but a few.

Examples of non-naturally-caused disasters capable of initiating a civilly-catastrophic event include both unintended events as well as intentional acts of aggression such as war, terrorism, madness, or the like. Examples of non-naturally-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, exposure to a harmful mutagenic influence, and so forth.

In addition, or in lieu thereof, such access can be further conditioned upon other criteria of interest or concern in a given application setting. Such conditional access can be absolute (as when a given individual may be denied any access to any of the civil security resources) or may be relative (as when a given individual is denied access to certain of the civil security resources while being allowed access to certain other of the civil security resources). As a simple illustrative example in this regard, a given individual may habitually and consistently exhibit highly anti-social behaviors; in such a case, the provider of such civil security resources may be willing to provide such a person with civil security provisions but may be reluctant to permit this person to have access to a long term shelter where a certain amount of social buoyancy and ability to compromise with others may be important to the long term ability of that facility to successfully protect its inhabitants.

A very wide variety of criteria can be potentially considered for such purposes. A few illustrative examples would include, but are certainly not limited to, an authorized beneficiary's qualifications (based upon their experiences, aptitude testing, physical condition and capabilities, or the like), measured intelligence (based upon, for example, a traditional intelligence quotient (IQ) test or the like), psychological test results, behavioral test results, race, nationality, citizenship, ancestry, sexual orientation, gender, age, height, weight, physical attributes including a physical deformity, health, political beliefs and/or agenda, educational background, professional title, financial backing, athletic ability, mechanical ability, skills, and/or relationship to a third party entity with whom reciprocal relations regarding the provision of private civil security resources exist (as when multiple providers of such provisions/facilities/services mutually agree to extend civilly-catastrophic event-based reciprocal access to one another's authorized beneficiaries).

As noted earlier, this process 100 will permit optionally providing 102 non-civil security resources. In such a case, this process 100 will then also provide 104 the authorized beneficiaries with consideration-based access to these non-civil security resources as well. Notwithstanding the provision of such civil security resources, this step of providing 103 access to such resources can readily comprise providing a plurality of different access opportunities which are detailed in commonly owned U.S. patent application Ser. No. 11/549,874, which is fully incorporated herein.

So configured, a given authorized beneficiary can obtain a viable, valuable, useful entree into a private civil security paradigm. A base line offering can be provided for a relatively modest initial cost and, if and as the authorized beneficiary becomes more learned and experienced with respect to civil security issues and concerns, additional supplemental kinds and levels of protection and security can be subsequently acquired as needed.

Referring now to FIGS. 1 and 3, a management system 300 may be provided to manage 105 the private civil security resources. The privatized civil security industry is a new and developing industry, and the service requirements of the industry require unique business model solutions. For example, disaster classifications and alerts, disaster response, data security, storage of supplies, rescue, training, transportation of large groups of people, and so forth are disparate service sectors that must be integrated and managed together within the privatized civil security system. Therefore it is important to develop a customized curriculum that cuts across and then ties together a multitude of previously unrelated industry sectors. Forming the management system 300 with disaster response computer hardware and/or software platforms offers one such approach to addressing the unique demands of privatized civil security.

The management system 300 may be an enterprise-wide system that is involved in all facets of providing the private civil security resources. Generally, this may include, but is not limited to, any of:

(1) gathering and/or managing information relating to characteristics of incidents such as civilly-catastrophic events or other events that could trigger use of the private civil security resources by authorized beneficiaries;

(2) gathering and/or managing information or profiles of the authorized beneficiaries to understand their needs and preferences as well as know the obligations to the authorized beneficiaries (for example, which civil security resources a particular authorized beneficiary purchased or has access to);

(3) analysis of all of the gathered information and data to establish a list of actions that need to be taken in light of an incident and whether by the provider or authorized beneficiaries (the actions may include preliminary plans and/or contingency instructions guiding authorized beneficiaries during a time of need when responding to a civilly-catastrophic event for instance);

(4) managing information regarding access to the civil security resources such as coordinating, obtaining, and/or maintaining the private civil security resources, the personnel providing the private civil security resources, and the business entity(s) providing the civil security resources;

(5) training of employees and authorized beneficiaries (civil security preparedness training to a name an example); and

(6) managing or performing any or all of the business functions for one or more of the civil security providers.

It will be understood that one or more of these general tasks may be performed by other than the management system 300, and instead by systems, networks, and/or computers that may be controlled by other providers of civil security resources. A group of such providers may be part of the same legal entity as the management system 300 or a different legal entity with an agreement with the provider of the management system 300. By one approach, at a minimum, the management system 300 is an incident deployment and response system that at least analyzes data relating to an incident in light of profile data from authorized beneficiaries to establish a list of appropriate actions to take regarding the private civil security resources.

In order to implement these tasks, the management system 300 may include a computer network (such as a local area network or intranet that may or may not use tunneling through a public network such as the Internet, to name a few examples). Thus, the management system 300 may be, or include, one or more computers such as a mainframe computer, a server, a desktop computer, a laptop computer, and a portable computer, as are known, and to name a few examples. The management system 300 may also include other hand-held computers having adequate memory and processing to perform the functions mentioned above, such as a personal data assistant (PDA), a telephone (whether it is a hard-wired phone, a cordless phone, a cellular phone, and/or a satellite phone, to name a few examples), an email transceiver device such as a BLACKBERRY, and any other similar device.

As shown in FIG. 3, the management system 300 may be easily accessible through a network 301 and to authorized beneficiaries 303, other providers 305 that assist with providing the private civil security resources, and other parties 302 such as governmental authorities, media outlets, others that maintain the management system 300, and/or any others that provide information or assistance to the provider of the management system 300. By one approach, intelligence gathering systems, such as threat assessment systems and databases therefore 306 may be controlled or maintained separately from the management system 300.

The network 301 may be a public network such as the Internet, for example, a local area network (LAN), a private or public intranet, or other known networks that can provide an adequate level of connectivity to the management system 300. By one approach, the management system 300 may be protected by a front-end or “store-front” computer or network 304 that is accessible to network 301 in order to provide an extra level of security from unauthorized electronic access into the management system 300 as is known in the art. In this case, the management system 300 may be a back-end, private network or computer that is not accessible from the public network 301 without proper security clearances (as may be verified through use of one or more passwords, usernames, access codes, and so forth).

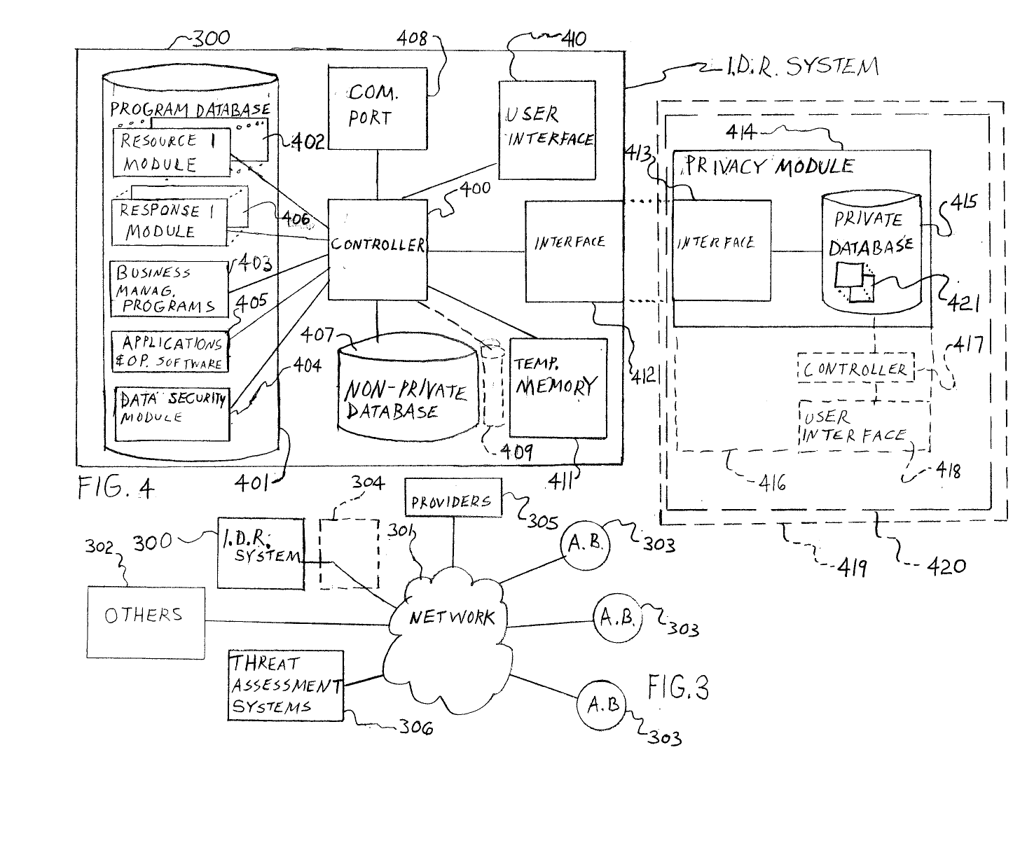

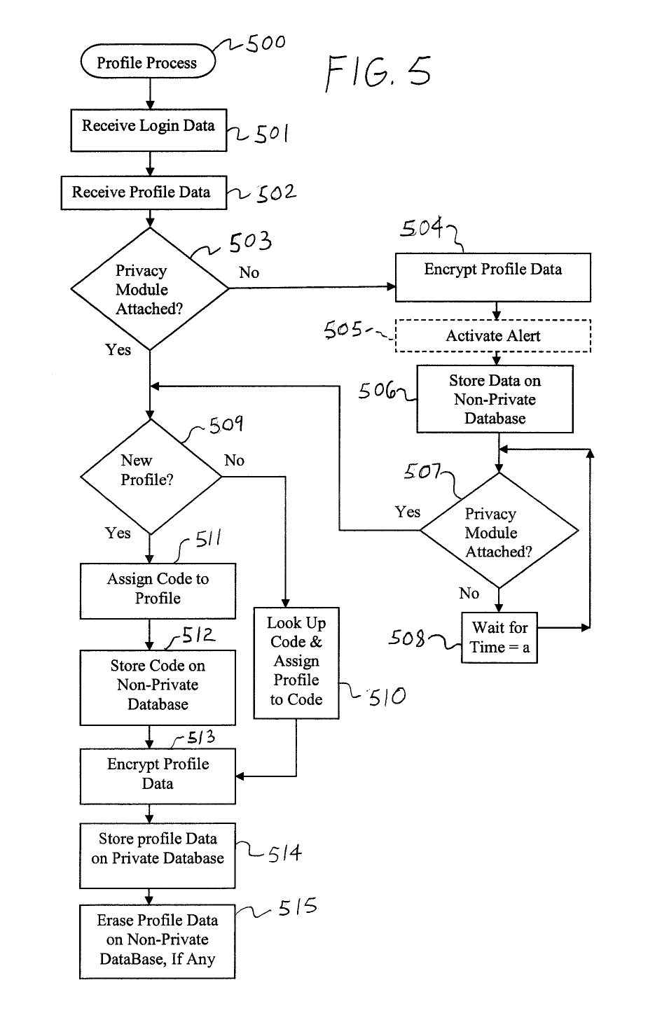

Referring now to FIG. 4, the management system 300 may have, at a minimum, one or more controllers 400 for processing data, a user interface 410 (such as work station or terminal to name a couple of examples) for operating the management system 300, a communications port 408 (for connection to the Internet or other network, for example), and a temporary memory 411 (such as random access memory (RAM) or any other similar-purpose memory) for holding activated programs and other data as is all well known in the art. The management system 300 may also have a data storage memory or database 401 for storing applications 405, programs, and modules 402-406. By one approach, a plurality of distinct modules 402, 404, and 406 can stand alone, interface with the management system 300, and/or be part of (stored on, for example) the management system 300. The modules 402-406, independently or as part of the management system 10, may perform many different tasks related to the civil security provider's obligations regarding civil security provisions, facilities, and services described above including evaluating a multitude of external data to, as an example, provide a real-time, multi-level response plan to a given disaster(s) to a world-wide network of authorized beneficiaries.

In order to provide a high level of security and privacy for the authorized beneficiaries, access to the profiles 421 of the authorized beneficiaries is restricted. In order to implement restrictions, the tasks performed by the management system 300 (and more specifically performed by one or more of the modules 402-406 mentioned above and explained in more detail below) may be categorized as either non-profile required tasks or profile-required tasks. The profile-required tasks include tasks that require access to particular information or parts of the profiles 421 of the authorized beneficiaries so that an activated module can perform the task. The information in the profile 421 may include data that an authorized beneficiary would prefer to keep confidential such as an authorized beneficiary's address or medication requirements to name some examples. The profile-required tasks may also be interchangeably referred to herein as profile-related tasks (even though all tasks may be considered related to the profiles of authorized beneficiaries on at least some very minimal level).

In contrast to the profile-required tasks, non-profile required tasks may be relatively irrelevant to the profiles 421 of the authorized beneficiaries and may run at any time whether or not access is provided to the profiles 421. More specifically now, the non-profile required tasks may be performed by modules, programs, and/or applications on, or connected to, the management system 300. These tasks may include at least one of the following examples:

a. Identifying characteristics of a civilly-catastrophic event or other incident that triggers the activation or use of the civil security resources including collecting, sorting, and/or analyzing incident data. This may further include operating or interfacing with an appropriately named alert status module or system, and a disaster classification module or system;

b. Managing natural business functions (by business management programs 403 as one example) of at least one provider of the civil security resources including functions of human resources, accounts payable, accounts receivable, supply chain management including inventory and purchasing, subscriber relationship management, marketing and sales to subscribers and renewals, and so forth;

c. Managing personnel of the providers of the civil security resources as far as profile-required data is unnecessary such as staffing (including, for example, staffing the business units, provision delivery and maintenance units, shelters, transportation, or rescue), disaster training, and providing training, assessments, and ratings of provider personnel to name a few examples;

d. Managing the computer devices establishing the management system and other computer related devices. This may include an in-house or out-sourced information technology (IT) department as is known;

e. Managing communications with at least one of: authorized beneficiaries, another civil security resource provider, governmental authorities, and/or any other provider of information relevant to civil security such as information regarding a civilly-catastrophic event. This can include, but is not limited to, providing and maintaining communications equipment, operating a website, informing parties when communications will take place, providing or identifying a protocol for such communications depending on the circumstances (such as during a particular type of civilly-catastrophic event), and so forth;

f. Managing supplies or equipment by coordinating with at least one of: authorized beneficiaries (such as when all authorized beneficiaries are provided instructions without entering into individual profiles for example), another civil security resource provider, governmental authorities, and/or any other provider of information or services relevant to civil security or the provider of private civil security resources;

g. Managing the civil security resources based on general statistics of the authorized beneficiaries. This may include running the modules described further below based on general collected knowledge of the authorized beneficiaries without using particular data that can identify a particular authorized beneficiary. For instance, it may be determined that a certain number of authorized beneficiaries live in a particular city, and therefore, an evacuation plan provided by a transportation module may calculate that a certain number of stops for a transportation service should be spread out evenly throughout that city. Many other examples, no doubt, exist; and

h. any other task that can be performed without providing access to the profiles.

The profile-required tasks, or at least tasks that may require access to some profile information of the authorized beneficiaries, may include, but is not limited to, the following (unless otherwise noted, the listed task may at least need information regarding a preference of the authorized beneficiary from their profile as relates to a particular civil security resource):

a. Tracking of authorized beneficiary specific products and services (where at least addresses of authorized beneficiaries may be needed);

b. Resource allocation of the service provider's disaster response activities for authorized beneficiaries, including, for example, for the business units, delivering units, shelters, transportation, rescue, and training;

c. Prioritization and timing of allocation of the service provider's disaster response activities for authorized beneficiaries, including, for example, for the business units delivering units, shelters, transportation, rescue, and training;

d. Operating and/or interfacing with a service provider's tactical operations center;

e. Analyzing and establishing actions in light of a civil security resources triggering incident (such as a civilly-catastrophic event). This may include operating or interfacing with a disaster response matrix module that is used to determine the correct actions. This may also include providing an information system accessible by the authorized beneficiaries to obtain real-time guidance as to what actions to take immediately (or at least near-term) with respect to a given civilly-catastrophic event;

f. Operating or interfacing with a resource module 402 that manages a particular civil security resource, may perform a number of the tasks mentioned above, and is explained further below; and/or

g. Operating or interfacing with a response module 406 that manages a particular civil security resource, may perform a number of the tasks mentioned above, and also is explained further below.

The resource modules 402 may be, in one example, a general-use or general-category module and may be used to coordinate, for example, all provisions, all facilities, or all services. In another example, a resource module 402 may be used to manage one particular type, category, or kind of resource. Examples include anything from a category such as short term shelters, all vehicles, or all foods to be maintained at a low temperature, to specific kinds of resources such as a facility at a particular location, a bus for a particular route for the transportation service, or all cheese, to name a few of many different possible examples. Along these lines, the management system 300 may have a civil security provisions module, a rotation and optimization module to track and maintain inventory of the provisions (and/or any other inventory related to the civil security provider), a transportation module, a rescue module, and a shelter module to name a few examples.

By one approach, a resource module 402 performs or assists with substantially all tasks related to that resource. Thus, the resource module 402 is used by the management system 300 to establish, or perform automatically when applicable, a list of instructions relating to the particular resource. Thus, for one example, the transportation module may provide documents, spread sheets, schedules, protocols, laws, communications, communication logs, checklists, contact lists, and so forth. These tools may be implemented to assist in tracking or planning of at least one of: procuring, organizing, prioritizing, inventorying, allocating, equipping, staffing, maintaining, delivering, positioning, moving, securing (from movement as one example), protecting, building, detailing, rotating, and/or providing instruction for use of vehicles, to name some examples. In this example, the vehicle may be for transporting people and/or to move the provisions or other equipment. Such a transportation module may be managing any number of vehicles from one to a fleet of vehicles.

Similarly, a provision module may perform at least one of: procuring, organizing, prioritizing, inventorying, allocating, making, maintaining, delivering, positioning, moving, securing (from movement as one example), protecting, and/or instructing for use of provisions, to name some examples.

Likewise, a facilities module may be used for procuring, organizing, prioritizing, inventorying, allocating, equipping, staffing, maintaining, delivering, positioning, moving, securing (from movement as one example), protecting, building, detailing, rotating, and/or providing instruction for use of facilities, to name but a few examples.

By another approach, a resource module 402 may be used to procure, prepare, and maintain a resource while a response module 406 is used to activate, deliver, and/or deploy the resource in light of a civilly-catastrophic event as one example. The response module 406 may be integrated with other modules to receive information from those other modules as is appropriate such as the response matrix module and a resource module 402 for a particularly relevant resource to name a few examples.

As can be understood from the above, many of the modules or programs may have some profile-required tasks and some non-profile required tasks. Other times, a module or program will perform one type and not the other with regard to the profiles. It will also be understood that a profile module that manages profiles may be its own module, may part of a resource module, a response module, or any other module, program, and so forth. A profile module may also be located on the management system 300 or on the privacy module 414, both or another location separate from the management system 300 and privacy module 414. Regardless of this structure, distinct security modules may be provided in order to restrict access to the profiles of the authorized beneficiaries on a need-to-know basis.

It will be understood that providing the security and privacy for the profiles may be an extra included service provided by the civil security provider in addition to providing the private civil security resources, and a corresponding additional cost may be involved. Otherwise, this security service may be provided for free, included in other costs, and even though authorized beneficiaries and/or subscribers may have signed a waiver that their profile information, or parts thereof, need not be kept confidential. This may be done to attempt to prevent any disruptions in service or problems with providing the civil security resources caused by unauthorized parties such as hackers, data resellers, or the like whether the threat is external or internal (such as from a provider employee). Alternatively, providing security and privacy for the profiles may be an agreed-upon term in an agreement between the civil security provider and the subscriber or authorized beneficiary. Thus, the term may specifically describe which information is to be kept private and which information need not be kept private, if any. This term may also explain what steps may be taken to attempt to maintain the privacy of the profile data.

By one approach, the process 100 further comprises at least electronically isolating 106 profiles of the authorized beneficiaries from access by the management system 10 at least while the management system is performing non-profile required tasks. To accomplish this, the management system 300 has a data security module 404 that performs a number of tasks to attempt to secure the profile data of the authorized beneficiaries. The data security module 404 may be a stand-alone module, may interface with the management system 300, or may be stored on the management system as shown on FIG. 4 as one example. The data security module 404 would permit access to the profiles for updating an existing profile of the authorized beneficiaries, adding a new profile, managing the plurality of the civil security resources in association with a civilly-catastrophic event, and/or any other process that requires access to the profiles as mentioned above such as for training exercises with a particular authorized beneficiary to name one example.

For these purposes, access to the profiles may be provided on an as-needed basis as may be desirable for before, during or after an imminently threatened civilly-catastrophic event, for example. Alternatively, or in addition, access to the profiles may be permitted on a substantially periodic basis. For this reason, in one example, access may be permitted to the profiles as is necessary and appropriate considering the physical location of the profile data in relation to the management system 300. Thus, if the profiles are stored on the management system 300, access may be provided once every one or two minutes to name a possible example, whereas if the profiles are stored on a remote database that is physically disconnected from the management system, providing access to the profiles once a day may be more appropriate. The time for access may be an exact time (4:00:00 pm daily) or may be a general rule (once a day or so without a specified time, for example). Many variations are possible.

By one approach, the profiles of the authorized beneficiaries are stored on a storage device 409 that is isolated from all communication ports and interfaces providing access to the management system 300 whether internal access (such as to other modules, computers that are part of the management system, and so forth) or external access (such as with ports to the Internet or to wall outlets at a civil security provider facility, or headquarters, to name a few examples). The storage device 409 may reside on the management system 300 while the data security module 404 controls access to the storage device 409. To accomplish this, the data security module 404 may use access blocking programs (such as firewalls), password or pass code security programs, and/or circuitry switches as are known in the art to stop data flow on a data pathway connected to the storage device.

By another approach, isolating profiles 421 of the authorized beneficiaries includes physically isolating the profiles 421 by storing the profiles on a privacy module 414 that is physically and selectively detachable, or separate from, the management system 300. The privacy module 414 has a data storage device 415 that holds the profiles 421. By one approach, the data storage device 415 substantially forms the privacy module 414 such that the main purpose, and in one example the only purpose, of the privacy module is to store data. In this case, the privacy module 414 may be a compact disc, an optically-based memory, a magneto-optically based memory, and/or a magnetically based memory with an interface 413 in the form of an exposed surface received by an interface 412 on the management system 300 that is in the form of a disc drive. In other examples, the privacy module 414 is an external hard drive or other memory drive selectively receiving the data storage device 415 and that is, in turn, selectively connected (by cable or dock to name a few examples) to the management system 300. The privacy module 414 may also be a magnetic tape, a thumb drive, a solid-state memory, a microchip, an integrated-circuit based memory, or any other type of article that is substantially a data storage memory and that may be removably mounted on, in, or otherwise coupled (through a physical or wireless connection) to an interface 413 on the management system 300.

By another approach, the privacy module 414 is a computer device 416 that has a plurality of purposes where storing data is one of the purposes. In this case, the privacy module 414 may be a mainframe computer, a server, a computer, a laptop computer, a portable computer, a hand-held computer, a personal data assistant (PDA), a telephone having a memory for storing data (such as a wireless phone, a cordless phone, a cellular phone, and a satellite phone to name a few examples), and an email transceiver device (such as a BLACKBERRY to name an example). The privacy module 414 may also be a computer network with a plurality of computers. In one example, at least two of the computers forming such a network have databases for storing profiles and that may be selectively, physically or electronically detachable from each other as well as detachable from the management system 300 in order to add an extra measure for security. So configured, access to at least some profile data might be stopped when an unauthorized entry on the computer network is detected.

Where structurally appropriate, the interface 412 of the management system 300 may be a dock that receives the privacy module 414 or a part of the privacy module forming the interface 413. The opposite may also occur where the privacy module forms the dock instead. Such docks may be a laptop dock, a BLACKBERRY dock, and so forth. The detachment from the dock may be performed electronically (by turning off the dock as one example) or physically (such as manually by hand, robot arm, or machine, for example). In either case, the detachment may be performed by activators or switches on the management system or privacy module, or may be performed remotely by a wireless or wired device that may be configured to control the dock, as is known.

Any of these computer devices 416 may also include its own controller 417 and user interface 418 that may be used to manipulate the profile data 421 stored on the privacy module 40. This may be convenient for reviewing, adding, or updating the profile data separately from the management system 300 if needed.

The interface 413 of the privacy module 414 and the interface 412 of the management system 300 may have one or more of many different configurations that provide the detachability for the privacy module 414. Thus, such a detachable connection may comprise at least one of: a connection that is manually, automatically, or remotely detachable (such as a plug connection for example), a communication port (such as a serial port, a universal serial bus (USB) port, a parallel port, and/or a line print terminal port to name a few examples), a wireless connection (such as an infrared-based connection, a cellular network-based connection, and/or a satellite network-based connection to name some examples), a digital-signal based connection (such as T1 or T3 line for example), a digital-subscriber line (DSL) based connection, or a telephone-based connection (such as a dial-up connection). The configurations for these and many other possible connections are known.

The attachment or detachment of these connections may be activated by an electronic or mechanical on/off switch. The switch itself may be manually operated and/or may be on a device (whether wireless or wired) remote from at least the management system 300 and the physically detachable connection therebetween.

By yet another approach, one or more privacy modules 414 may be physically manipulated by a library device 420 to eliminate the need to rely on personnel to manually move a privacy module to and from the management system 300 in order to increase the degree of security and eliminate labor costs. The library device 420 may be configured to selectively grasp a desired privacy module 414, carry the privacy module 414 to the interface 412 of the management system 300, and/or connect the privacy module 414 to the management system 300. The library device 420 may also perform the opposite operation of removing the privacy module 414 from the management system 300 and placing the privacy module 414 on a storage mechanism such as a shelf configured for storing one or more of the privacy modules 414. Such library devices 420 may have robotic arms and grasping hands, sliding bars, and so forth as is well known in the art.

By still another approach, the privacy module 414, and library device 420 if present, may be stored in at least one secure room 419 that is separate from the management system 300. The secure room 419 may be sufficiently large for at least one person to walk in. The secure room 419, however, may be any locked container with sufficient space to store the privacy module 414 such as a vault, safe, closet, cabinet, and so forth.

By one approach, the secure room 419 is mainly provided to store the privacy module 414 while the profiles 421 are not being used. In this case, the privacy module 414 may be removed from the secure room 419 by a machine such as the library device 420 for connection to the management system 300. In another alternative, a person must enter the secure room 419 in order to remove the privacy module 414. This provides an extra measure of protection by restricting entry into the secure room 419 to only those personnel with the proper security clearance (explained in greater detail below). The privacy module 414 may then be removed from the secure room 419 by the authorized person to connect the privacy module 414 to the management system 300.

Alternatively, or additionally, the privacy module 414 may be configured to remain in the secure room 419 for security purposes. The privacy module 414, in this case, is selectively electronically connected to the management system 300 from within the secure room 419. This may be accomplished by providing a connection to the management system 300 in the secure room.

Thus, when a physical, detachable connection between the management system 300 and the privacy module 414 is positioned within the secure room, a person may need to enter the secure room 419 in order to insert a plug into a socket of a detachable plug connection, for example. Alternatively, the privacy module may have a connector that extends out of the secure room while an activator or switch to activate an electrical connection between the management system 300 and the privacy module 414 may remain in the secure room. In this case, the actual physical connection may be anywhere convenient. Thus, for example, a connection may be activated by providing a switch activator in the secure room (whether a physical switch, an electronic switch caused by an entry on a computer interface, and so forth) while wires maintain a connection between the management system 300 and the privacy module 414. Similarly, a connection may be provided by a modem activator in the secure room, or a wireless data transmission activator in the secure room, where the activation of the connection is controlled in the secure room while many of the physical components forming the connection (such as wires or antennas) are outside of the secure room.

In another alternative, a connection may provide a download to hard copy of profiles in the secure room 419 (such as by a printer or plotter in the secure room or by permitting a transmission for printing or plotting at another location other than the secure room). These profiles may then be manually (by typing for example) or electronically (by scanning for example) placed into the management system 300. Similarly, a secure activation switch may provide for a download to another data storage device that is removable from the secure room. This additional data storage device may then be used to upload the profile data on the management system 300 or other appropriate storage location.

In order to restrict access to the secure room 419, the secure room may be heavily fortified with thickened and strengthened walls and windows, if present at all, as well as strengthened redundant locks, and so forth on all entry ways to the secure room. Guards (security personnel or animals such as dogs for example) may also be posted at the entry ways or may travel around the secure room as is appropriate. Personnel desiring entry into the secure room may be required to have the proper security clearance. Thus, such personnel may be required to show or prove identification before entering the secure room. This may be accomplished with the use of a biometric reader of deoxyribonucleic acid (DNA), a retinal pattern, an asperity pattern (such as a fingerprint, a palm print, or the like), a voice print, a characteristic typing pattern, and so forth. Identification of the personnel may also be accomplished by a key (such as a physical lock key), an identification card with a photo or a pass code, a separate pass code typed into a keypad, a password, a still image, a video image, a written authorization document, and/or an electronic authorization document to name a number of possible examples.

By another approach, at least one surveillance device is provided for detecting unauthorized entry into the secure room 419. Surveillance may be accomplished by lighting the inside or outer perimeter of the secure room 419 as well as recording images or providing a real-time image to close circuit televisions. The cameras may show or record the inside of the secure room 419, entry ways into the secure room, outer walls of the secure room, and/or access ways (such as hallways or sidewalks) that lead to the secure room. Cameras providing the images may have night vision capabilities such as infrared, thermal, or low light intensifier technologies.

Surveillance may also include the use of motion detectors inside and outside of the secure room 419, and/or sensors for detecting unauthorized entry into the secure room such as by breaking or picking locks or by opening of accessways.

By one approach, electronic devices including the privacy module 414 in the secure room 419 and/or the device or devices forming a detachable connection between the privacy module 414 and the management system 300, no matter the location of such connection, may be monitored to indicate when unauthorized use is occurring. This may be performed electronically by software that automatically indicates unauthorized access or that provides a user to monitor the electronic access through a terminal or other interface. Optionally, a connection device may have indicators such as a light, sound alarms, and/or displays so that a user can observe the indicators on a connection device.

Once an intruder is detected in the secure room 419 or using the computers or equipment in the secure room, an alarm may be sounded and barriers may be erected in response to the alarm. The barriers may include physical barriers such as plates or bars covering the doors and windows, or electronic barriers such as electrical fences being activated around the secure room 419. Indication of the presence of the intruder or an unauthorized event in the secure room 419 may also be transmitted to appropriate parties such as security personnel, authorities, owners of the civil security provider, and the like.

By another approach, once an intruder is detected in the secure room 419 and/or using a computer that has access to the profile data, that computer (or selected ones or all of the computers in the secure) may at least be rendered at least partially inoperable (such as by locking-up or freezing the computer or certain programs on the computer, shutting-down the computer, turning the computer off, and so forth). Instead, or additionally, profile data accessible to a breached computer (whether in or out of the secure room) may be automatically or selectively erased. In such a case, one or more storage devices may be provided for storing back-up profile data, and may be disposed in the same secure room or a separate secure room than the secure room 419 holding the primary profile data storage devices. The back-up storage devices may also have the same or different configurations as described herein for the storage devices for the primary profile (such that they may be part of a privacy module as described herein as one example). The access to the back-up storage devices may be restricted as desired. In one instance, the back-up profiles are accessible only for updating profiles and upon the erasure of the primary profiles, although many other configurations are possible. It will also be understood that the back-up storage devices may store non-profile data alone or with profile data.

By yet another approach, paper records of the profiles, information related to access of the profiles, and/or other non-profile related information may be stored for safe keeping. Such access related information may indicate a person, time, date, duration, and/or specific profile data accessed, to name but a few examples. The paper records may be stored in secure room 419 with the primary profile data or a separate secure room that is remote from secure room 419 and/or management system 300. Access to the paper records may be restricted for emergency purposes as when primary profile data is lost, as one example, or for any other purposes, as desired.

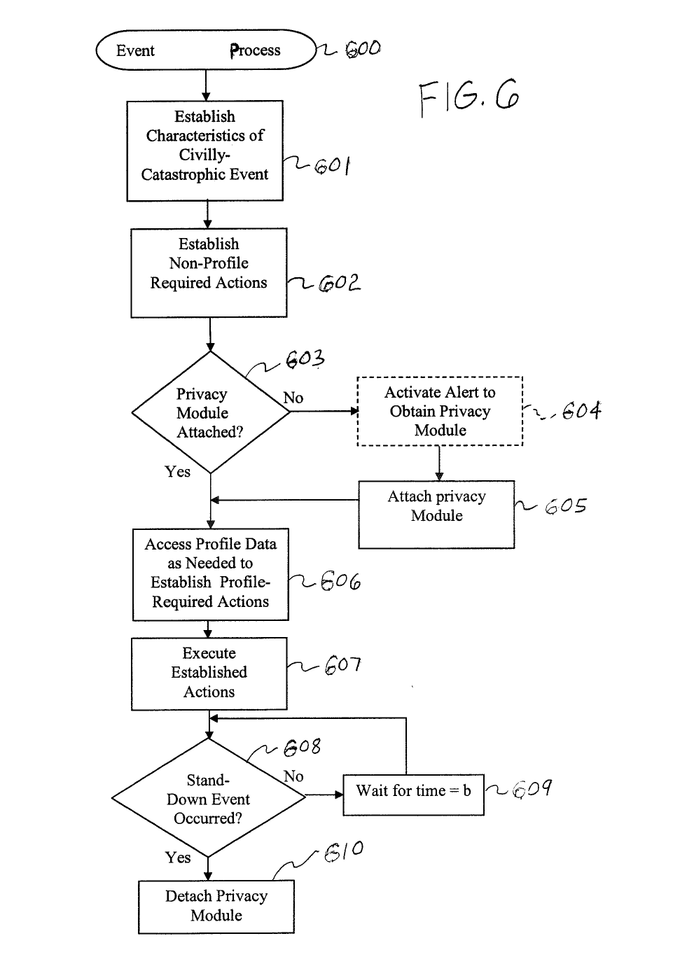

Referring now to FIGS. 4-5, the data security module 404 performs a number of steps of a profile process 500 performed on the management system 300. It will be understood, however, that the data security module 404 alone, or another appropriate system communicating with the management system 300 or providing data to the management system 10, may be used in lieu of the management system 300. In order to receive profile data from authorized beneficiaries, the process 500 starts with receiving login data 501 from either an authorized beneficiary or their representative logging into a civil security provider website for example. Alternatively, personnel of the civil security provider may have obtained the profile data and is responsible for entering the profile data into the management system 300. The personnel then logs into a terminal accessible to the management system 300 to enter the profile data into the management system. This terminal may be at the headquarters or other facility of the civil security provider for example or at a different location (such as at home or another provider, for example). The login may require identifying entries such as passwords, usernames, and answers to questions only an authorized beneficiary would know, as is known.

Next, the profile data is received 502 by the management system 300 whether from the authorized beneficiaries, their representatives, profile processing or intelligence gathering personnel of the civil security providers, or others. The profile data may include any information that may be used for contacting, finding, or identifying authorized beneficiaries; determining which private civil security resources the authorized beneficiaries are entitled to access; and the preferences and needs of the authorized beneficiaries relating to the private civil security resources. The profile data may also include information regarding access restrictions as mentioned previously (such as for authorized beneficiaries with anti-social behavior) as well as the financial status of the authorized beneficiaries.

By one approach, the profile data may include identification data such as at least one of: a legal name, a nickname, a phone number (such as a home number or numbers, office numbers, and so forth), an address (home, office, and so forth), identification numbers (such as a social security number, driver's license number, credit card number, and so forth), an email address (such as home(s), office(s), for example), a general description (including at least one of: weight, height, gender, age, hair color, hair style, skin color, skin marks, tattoos of any picture, word, or symbol, eye wear, other physical attributes or deformity, and so forth), disabilities, race, nationality, citizenship, ancestry, and/or sexual orientation. Other profile data may relate to relationships of the authorized beneficiaries such as at least one of: an indication of other authorized beneficiaries relating to the authorized beneficiary of the profile, a family member, an heir, an executor of an authorized beneficiary's estate, a political agenda, a group to which the authorized beneficiary belongs, a pet, an educational background, a profession, and/or a financial condition.

Yet other profile data may relate to the overall health, skills, personality, and abilities of the authorized beneficiaries and may include at least one of: an authorized beneficiary's measured intelligence, an authorized beneficiary's psychological test results, an authorized beneficiary's behavioral test results, health record, athletic ability, mechanical ability, skills, medication being taken, a medical condition, a psychological condition, a dietary preference, and/or a dietary restriction. Other profile data may relate to the services that are being provided and the authorized beneficiaries' relationship with the civil security provider such as at least one of: a description of civil security resources accessible to the authorized beneficiary, a reason an authorized beneficiary is denied access to a civil security resource, the reasons a resource may be provided with unusual restrictions, a financial record relating to access to the civil security resources, a preference relating to a civil security provision, a preference relating to a civil security service, and/or a preference relating to a civil security facility.

Once the profile data is obtained, it is determined if the privacy module 414 is attached 503 to the management system 300 and accessible. If the privacy module 414 is not accessible, the profile data may be encrypted 504 as quickly as possible and stored 506 on a non-private database 407 on the management system 300 or other relatively safe location. In one form, the process 500 provides 505 an alert for indicating that profile data is stored on the non-private database 407. This alert may simply show up on the terminal of the personnel entering the data, or if none, the alert may show up on the computer of other personnel responsible for connecting a private database forming storage unit 415 on the privacy module 40 to the management system 300 to provide access to the profiles on the private database.

By another approach, no alert is needed because the privacy module 414 is periodically attached to the management system 300 either manually or automatically, as explained above. By another approach, the presence of the profile data on the non-private database 407 triggers automatic attachment of the privacy module by machine. Either way, the management system 300 may be placed in a loop where it checks for the attachment 507 of the privacy module 414, and then waits 508 for a predetermined time until it checks again. It will be understood that other methods than the wait loop are known and may be used.

Once the privacy module 414 is at least electronically connected to the management system 300, and the profiles 421 on the private database 415 of the privacy module 40 are accessible, the system 300 checks to see whether the received profile data relates to an existing profile or a new profile. If the profile is new, the data security module 404 assigns 511 at least one code to correspond to the profile. One code may be assigned to each authorized beneficiary or an organized group (such as a corporation for example) or family of authorized beneficiaries. These codes are used by the civil security personnel and others providing the civil security resources instead of using the profile data, or a portion of the profile data, in order to maintain the privacy of the authorized beneficiaries. Once the code is assigned, the code is stored 512 on the non-private database 407 where it is accessible for use by the appropriate personnel of the civil security provider.

The profile data as well as the correspondence between the profile data and its assigned code or codes are encrypted 513 and stored 514 on the private database 415 on the privacy module 414. After the profile data is stored on the private database 415, the profile data on the non-private database is erased 515 although it may be deleted instead. The term “erase” as it is used here is known in the art to mean cleaned off and more than simply “deleted” which generally means not saved so that it can be written over. For updating an already existing profile, the same general procedure applies except that the code is already saved on the management system 300 and a new code is not assigned. Instead, the data security module 404 looks up 510 the code on the privacy module 414, and assigns the updated profile data to the appropriate code.

Once stored, and while the private database 415 is accessible, civil security resources may be assigned to a code that correspond to a particular authorized beneficiary. Thereafter, personnel providing the civil security resources need only prepare the resources for a particular code while the identity of the authorized beneficiary remains hidden.

It will be understood that the code may be a predetermined number of symbols (such as 10 digits for one example) and may, by one approach, include randomly selected numbers and letters. By another approach, the code may represent or include a number that corresponds to the chronological order, or any other known order, by which the authorized beneficiary performed a certain provider-related action. This action may be (a) when the authorized beneficiary obtained a promise for access to the civil security resources, (b) became a member of an entity providing the civil security resources, (c) logged into the management system 300 a first time, (d) submitted a profile to the management system 300, and so forth.

Alternatively or additionally, the code may conveniently provide information for a number of different categories or things useful for the personnel providing civil security resources. For instance, an exemplary code is provided as follows:

A1234567890

Where the ‘A’ represents the class or kind of membership or agreement entitling the authorized beneficiary to different levels of service as to quality, amount, speed, and so forth. The first three digits (123) may correspond to a location of the authorized beneficiary (where 123 is assigned a particular city or other area), while the next three digits (456) may correspond to a type, or types, of civil security resource to be provided to an authorized beneficiary (such as 4=rescue, 5=transport, 6=shelter). The last four digits may correspond to a way in which a civil security resource is to be provided to an authorized beneficiary (for example 7 may mean medication required for provisions, 8 may mean wheel chair transportation needed, 9 may mean shelter with handicap access, 0 may mean provide services without calling first, to name a few of many possible examples).

Referring now to FIGS. 4 and 6, an event process 600 is explained and relates to the deployment and response to an incident such as civilly-catastrophic event, for example, that triggers the deployment of the private civil security resources. Once the characteristics of the event are established 601, the management system 300 immediately use the modules 402, 404, and/or 406 to establish 602 and/or perform non-profile required actions as described above. The management system 300 also checks 603 to see if the privacy module 40 is connected and profile data is accessible. If the privacy module 414 is not connected, the management system 300 proceeds (as described above for updating profiles) by activating 604 an alert, if applicable, to indicate that the privacy module and its profiles are needed, or by otherwise automatically obtaining the privacy module. Once the privacy module is attached 605 to the management system 300, the profiles are accessed 606. The personnel accessing the profiles may still be restricted to which information is accessed according to their assigned security clearance level explained further below. With the privacy module 40 attached, the profile-required actions are established. All actions are then executed 607 to provide the authorized beneficiaries with the private civil security resources. It will be appreciated that instead of the above, the process may wait for the profile module 40 to be accessible before establishing any actions whether or not the profiles 421 are required.

The management system 300 is then placed in a loop where it checks 608 for indication of a stand-down event and then waits 609 for a predetermined time period until it rechecks for the stand-down event. Once a stand-down event is deemed to have occurred, the privacy module 414 is detached 610 from the management system 300 and placed in secure storage as described above. A stand-down event may be an announcement by authorities relating to a condition of a civilly-catastrophic event, and/or a conclusion based on threat assessment data relating to the civilly-catastrophic event (such as sensor data, real-time observations, predictions (based on past statistics for example), indicators of an imminent end of the civilly-catastrophic event (for example flood waters receding), an indication of an end of civil upheaval that is at least substantially caused by the civilly-catastrophic event, and/or any combination thereof).

In another aspect, the data security module 404 may be used to assign security clearance levels to personnel of the civil security provider and/or any other providers of the private civil security resources, and to coordinate data so that only particular profile data is accessible to personnel of a certain security clearance level that needs that particular data to perform their jobs. In other words, the personnel are restricted to profile data on a need-to-know basis. For example, security clearances levels may be assigned as follows:

LEVEL 0—NO PROFILE TASKS—personnel that only perform non-profile required tasks have substantially no access to the profiles of authorized beneficiaries.

LEVEL 1—LIMITED PROFILE TASKS—personnel that perform tasks for a certain type of civil security resource only have access to profile data of authorized beneficiaries related to the certain type of civil security resource. Instead, the personnel are provided with the code described above that uniquely relates to a given authorized beneficiary or beneficiaries in lieu of other identifying information to facilitate the particular profile-required tasks as carried out by the personnel. For example, when the particular profile-required task is at least delivering objects to authorized beneficiaries and/or transporting authorized beneficiaries, the personnel may only be provided the code and the addresses of the authorized beneficiaries that correspond to the code for this task. As another example, when the particular profile-related task comprises at least stocking the private civil security provisions for an indicated authorized beneficiary, the personnel may only be provided a code and a list of provisions as correspond to the indicated authorized beneficiary for such a task. As yet another example, when the particular profile-related tasks comprise at least maintaining the private civil security facilities, the personnel may be provided with only a code and a facility-related preference list of the authorized beneficiaries corresponding to that code.

LEVEL 2—BENEFICIARY IDENTIFICATION—personnel responsible for identifying an indicated authorized beneficiary may be provided with all identification information, but no other information, related to the indicated authorized beneficiary. This may occur when a transport needs to pick-up an authorized beneficiary when it is expected that unauthorized individuals may attempt to board the transport. This may also occur when the personnel are assigned to find and rescue the authorized beneficiary.

LEVEL 3—BENEFICIARY ASSIGNMENT—when personnel are assigned to coordinate all civil security resources for one or more particular authorized beneficiaries, the personnel may have access to all of the profile data of the particular authorized beneficiaries assigned to the personnel. The personnel would not have access to profiles of any other authorized beneficiaries.

LEVEL 4—MANAGER—when personnel are assigned coordination of a plurality of the civil security resources and multiple authorized beneficiaries, the personnel may have access to substantially all profile date of the authorized beneficiaries.

It will be understood that the security clearance level structure described herein is merely one example of how security clearance levels could be assigned and applied and many other examples exist. These security clearance levels may be permanent or may be changed with changing conditions of the personnel, the provider, the resources, and/or an incident or civilly-catastrophic event. In one example, the security clearance levels are provided on a task-by-task basis such that personnel performing multiple jobs may have varying security clearance levels depending on the job they are to perform. In other cases, the personnel may be limited to a certain security clearance level and cannot perform jobs with a different security clearance level. Many other examples and variations exist.

Those skilled in the art will recognize and appreciate that the above described teachings can be applied and leveraged in a variety of ways to achieve a significant number of tangible and concrete benefits while being reasonably assured that their personal, sensitive information should be well protected. These benefits include, but are not limited to, facilitating a relatively higher degree of personal awareness regarding civil security issues, a relatively higher level of resources availability, and/or a relatively more powerful set of motivations for various parties to adopt behaviors that in turn prompt an increased availability of potentially life-preserving resources for a relatively wide consuming audience than might likely be achieved in the absence of such teachings.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

I claim:

1. A method comprising:
providing a plurality of private civil security resources comprising, at least in part:
civil security provisions;
civil security facilities; and
civil security services;
providing authorized beneficiaries with consideration-based access to the plurality of private civil security resources;
managing at least the private civil security resources with a management system; and
at least electronically isolating profiles of the authorized beneficiaries from access by the management system at least while the management system is performing non-profile required tasks.

2. The method of claim 1 wherein the consideration-based access comprises at least one of:
a time-limited right of access;
an event-limited right of access;
an inheritable right of access;
a right of access predicated upon a series of periodic payments;
a right of access predicated upon a one-time payment;
an ownership-based right of access;
a non-transferable right of access;
a transferable right of access;
a membership-based right of access;
a fractional ownership-based right of access;
a non-ownership-based right of access;
an option-based right of access;
a credit-based right of access.

3. The method of claim 2 wherein providing authorized beneficiaries with consideration-based access to the plurality of private civil security resources further comprises conditioning the access upon at least one of:
an authorized beneficiary's qualifications;
an authorized beneficiary's measured intelligence;
an authorized beneficiary's psychological test results;
an authorized beneficiary's behavioral test results;
an authorized beneficiary's race;
an authorized beneficiary's nationality;
an authorized beneficiary's citizenship;
an authorized beneficiary's ancestry;
an authorized beneficiary's sexual orientation;
an authorized beneficiary's gender;
an authorized beneficiary's age;
an authorized beneficiary's height;
an authorized beneficiary's weight;
an authorized beneficiary's physical attributes;
an authorized beneficiary's health;
an authorized beneficiary's political agenda;
an authorized beneficiary's educational background;
an authorized beneficiary's professional title;
an authorized beneficiary's financial backing;
an authorized beneficiary's athletic ability;
an authorized beneficiary's mechanical ability;
an authorized beneficiary's skills;
an authorized beneficiary's relationship to a third party entity with whom reciprocal relations regarding a provision of private civil security resources exist.

4. The method of claim 1 wherein the civil security provisions comprise a plurality of resources as pertain to at least one of:
a life-sustaining resource;
breathable air;
fluids;
water;
food;
protective clothing;
a shelter;
a medical supply;
a personal hygiene supply;
an environmental threat abatement supply;
a luxury item.

5. The method of claim 1 wherein the civil security facilities comprise at least one of:
a civil security shelter;
a rally point at which the authorized beneficiaries can gather in response to a civilly-catastrophic event in order to receive the civil security services;
a location where at least some of the authorized beneficiary's civil security provisions are available;
a trans-shipment facility for at least some of the civil security provisions;
a medical services facility.

6. The method of claim 1 wherein the civil security services comprise at least one of:
transportation away from a location that substantially lacks civil security;
transportation to a civil security facility;
civil security information for at least one of individual ones and any of the authorized beneficiaries;
civil security information that comprises contingency instructions to guide the authorized beneficiary during a time of need when responding to a civilly-catastrophic event;
civil security preparedness training;
a long distance communications service that is configured and arranged to provide persistent communication services notwithstanding interaction of the long distance communication service with effects of a civilly-catastrophic event;
a rescue service to retrieve selected beneficiaries from dangerous circumstances owing, at least in part, to a substantial lack of civil security;
delivery of at least a portion of the civil security provisions;
transport of dispossessed persons;
physical security;
medical services;
post-civilly-catastrophic event social relationship facilitation;
delivery of fuel;
installation of independent utilities facilities.

7. The method of claim 1 wherein the management system further comprises an information system that an authorized beneficiary can access to receive substantially real-time advice regarding near-term actions to take with respect to a given civilly-catastrophic event.

8. The method of claim 1, further comprising:
accepting consideration-based private civil security subscriptions from subscribers with respect to providing the consideration-based access to the plurality of private civil security resources.

9. The method of claim 1 wherein providing authorized beneficiaries with consideration-based access to the plurality of private civil security resources comprises only providing access in association with a civilly-catastrophic event.

10. The method of claim 1 wherein the management system manages deployment of the private civil security resources in response to an incident.

11. The method of claim 1 wherein managing at least the private civil security resources with a management system further comprises providing instructions for performing at least one of:
procuring;
equipping;
staffing;
maintaining;
allocating;
delivering
positioning;
moving;
organizing;
prioritizing;
inventorying;
securing;
protecting;
rotating;
building;
detailing;
instructing for use;
of at least one vehicle.

12. The method of claim 1 wherein managing at least the private civil security resources with a management system further comprises providing instructions for performing at least one of:
procuring;
maintaining;
allocating;
delivering positioning;
moving;
organizing;
prioritizing;
inventorying;
securing;
protecting;
rotating;
making;
instructing for use;
of at least one provision.

13. The method of claim 1 wherein managing at least the private civil security resources with a management system further comprises providing instructions for performing at least one of:
procuring;
equipping;
staffing;
maintaining;
allocating;
delivering
positioning;
moving;
organizing;
prioritizing;
inventorying;
securing;
protecting;
rotating;
building;
detailing;
instructing for use;
of at least one facility.

14. The method of claim 1 wherein managing at least the private civil security resources with a management system further comprises managing at least one of:
information regarding the characteristics of a civilly-catastrophic event;
information regarding access to the private civil security resources;
contingency instructions to guide the authorized beneficiary during a time of need when responding to a civilly-catastrophic event;
civil security preparedness training.

15. The method of claim 1 wherein the non-profile required tasks performed by the management system comprise at least one of:
identifying characteristics of a civilly-catastrophic event;
managing a business of at least one provider of the private civil security resources;
managing personnel providing the private civil security resources;
managing computer devices establishing the management system;
managing communications with at least one of:
authorized beneficiaries;
another civil security resources provider;
governmental authorities;
providers of information regarding a civilly-catastrophic event;
managing supplies by coordinating with at least one of:
authorized beneficiaries;
another civil security resources provider;
governmental authorities;
providers of information regarding a civilly-catastrophic event;
managing equipment by coordinating with at least one of:
authorized beneficiaries;
another civil security resources provider;
governmental authorities;
providers of information regarding a civilly-catastrophic event;
managing the civil security resources based on general statistics of the authorized beneficiaries.

16. The method of claim 1, further comprising:
providing access to the profiles of the authorized beneficiaries for the management system for at least one of:
updating an existing profile of the profiles of the authorized beneficiaries;
adding a new profile to the profiles of the authorized beneficiaries;
managing the plurality of the civil security resources in association with a civilly-catastrophic event;
training exercises with a particular authorized beneficiary.

17. The method of claim 1, further comprising;
providing access to the profiles of the authorized beneficiaries for the management system on at least one of:
a substantially periodic basis;
an as-needed basis.

18. The method of claim 1 wherein at least electronically isolating profiles of the authorized beneficiaries comprises isolating at least a storage device storing the profiles of the authorized beneficiaries from all communication ports and interfaces providing access to the management system.

19. The method of claim 18 wherein the storage device resides on the management system, and wherein the storage device is isolated by using at least one of:
an access blocking program;
a switch configured and arranged to substantially stop data flow on a data pathway connected to the storage device;
a password.

20. The method of claim 1 wherein managing at least private civil security resources with a management system comprises providing the management system with at least one of:
a computer network;
a mainframe computer;
a server;
a computer;
a laptop computer;
a portable computer;
a hand-held computer;
a personal data assistant;
a telephone having a memory for storing data;
an email transceiver device.

21. The method of claim 1 wherein at least electronically isolating profiles of the authorized beneficiaries includes physically isolating at least one data storage device storing profiles of the authorized beneficiaries from the management system.

22. The method of claim 21 wherein the at least one data storage device is part of at least one privacy module configured to be selectively detachable from the management system.

23. The method of claim 22 wherein the at least one data storage device substantially forms the at least one privacy module.

24. The method of claim 22 wherein the at least one privacy module is at least one of:
a compact disc;
an optically-based memory;
a magneto-optically based memory;
a magnetically based memory;
a hard drive;
a memory drive selectively receiving the data storage device;
a magnetic tape;
a thumb drive;
a solid-state memory;
a microchip;
an integrated-circuit based memory.

25. The method of claim 22 wherein the at least one privacy module is configured and arranged so that storing data is one of a plurality of purposes provided by the at least one privacy module.

26. The method of claim 22 wherein the at least one privacy module is at least one of:
a computer network having a plurality of computers being at least one of: physically;
electronically detachable from each other;
a mainframe computer;
a server;
a computer;
a laptop computer;
a portable computer;
a hand-held computer;
a personal data assistant;
a telephone having a memory for storing data;
an email transceiver device.

27. The method of claim 26 wherein the at least one privacy module is the computer network, and wherein the profiles are stored on a plurality of databases on at least two of the plurality of computers.

28. The method of claim 22 wherein the at least one privacy module and the management system each have at least one interface configured for connecting to each other, and wherein one interface is a dock for receiving the other interface.

29. The method of claim 28 wherein the dock is at least one of manually and remotely operated for disconnecting the at least one privacy module from the management system.

30. The method of claim 22 wherein physically isolating a data storage device comprises providing a detachable connection between the privacy module and the management system wherein the detachable connection comprises at least one of:
a plug connection;
a communication port;
a serial port;
a universal serial bus port;
a parallel port;
a line print terminal port;
a wireless connection;
an infrared-based connection;
a digital-signal based connection;
a digital-subscriber based connection;
a telephone-based connection;
a cellular network-based connection;
a satellite network-based connection;
a connection configured for being manually detached;
a connection detachable by a switch;
a connection detachable by operating a remote device wherein remote is relative to at least the connection and the management system.

31. The method of claim 22 wherein physically isolating a data storage device comprises providing a library device configured and arranged for detachably connecting a selected one of the at least one privacy modules to the management system.

32. The method of claim 22 wherein physically isolating at least one data storage device comprises providing at least one secure room for storing the at least one privacy module.

33. The method of claim 32 wherein providing at least one secure room comprises permitting entry into the secure room to only personnel having a predetermined security clearance.

34. The method of claim 32 wherein providing at least one secure room comprises identifying a person requesting entry into the at least one secure room by at least one of:
a biometric;
an identification card;
a pass code;
a password;
a still image;
a video image;
a written authorization document;
an electronic authorization document.

35. The method of claim 32 wherein providing at least one secure room comprises providing at least one surveillance device configured for detecting unauthorized actions relating to the at least one secure room.

36. The method of claim 35 wherein providing at least one surveillance device comprises providing at least one surveillance device for at least one of:
lighting relating to the secure room;
recording images relating to the secure room;
providing a real-time image relating to the secure room;
detecting motion relating to the secure room;
detecting unauthorized electronic activity in the secure room;
detecting unauthorized entry into the secure room;
triggering an alarm relating to the secure room;
establishing a barrier in response to an alarm relating the secure room;
transmitting an indication of an unauthorized event relating to the secure room;
placing computers in the secure room in an at least partially inoperable state;
erasing profiles of the authorized beneficiaries stored in the secure room.

37. The method of claim 36 wherein the surveillance device erases profile data stored in the secure room, and wherein back-up storage devices pre-stored with profiles are made accessible upon the erasing of the profiles of the authorized beneficiaries.

38. The method of claim 32 wherein providing at least one secure room comprises providing at least one guard for restricting access to the at least one secure room.

39. The method of claim 32 wherein providing at least one secure room comprises providing data from the at least one privacy module by at least one of:
detachably forming a plug connection in the at least one secure room;
providing a switch activator disposed in the secure room;
providing a modem activator in the secure room;
providing a wireless data transmission activator in the secure room;
providing a download to hard copy of profiles in the secure room;
providing a download to a data storage device being removable from the secure room;
moving the privacy module out of the secure room.

40. The method of claim 21 further comprising:
providing at least one storage device storing back-up data comprising at least one of:
profile data;
data other than profile data;
both profile and non-profile data.

41. The method of claim 40 wherein the at least one storage device storing back-up data is disposed at least at one of:
a same location as a location holding the at least one storage device storing profile data;
a different location that is other than the location holding the at least one storage device storing profile data,
wherein the location of the at least one storage device holding back-up data has at least one mechanism to protect against unauthorized access into the back-up data.

42. The method of claim 1 wherein at least electronically isolating profiles of the authorized beneficiaries further comprises monitoring a connection providing access to the profiles while the profiles are accessible to the management system for detecting unauthorized access to the profiles.

43. The method of claim 42 wherein the connection is monitored by at least one of:
electronically;
software configured to automatically indicate unauthorized access;
a user;
physically watching a device forming the connection.

44. The method of claim 1 wherein at least electronically isolating profiles of the authorized beneficiaries further comprises providing a paper record in a location having devices to secure the location from unauthorized access to the paper record and for recording at least one of: profiles; records relating to access to the profiles; non-profile related records.

45. The method of claim 1 wherein at least electronically isolating profiles of the authorized beneficiaries further comprises:
receiving profile data of the profiles of the authorized beneficiaries while a private database for storing the profile data is detached from the management system;
encrypting the profile data;
storing the profile data on at least one non-private database accessible by the management system until the private database is electronically connected to the management system.

46. The method of claim 45 wherein at least electronically isolating profiles of the authorized beneficiaries further comprises activating an alert to indicate profile data is present on the at least one non-private database.

47. The method of claim 45 wherein at least electronically isolating profiles of the authorized beneficiaries further comprises erasing the profile data from the at least one non-private database once the profile data is copied to the private database.

48. The method of claim 45 wherein at least electronically isolating profiles of the authorized beneficiaries further comprises:
determining when the profile data is a new profile;
assigning a code to at least one authorized beneficiary associated with the new profile; and
storing the code on the at least one non-private database.

49. The method of claim 48 wherein at least electronically isolating profiles of the authorized beneficiaries further comprises:
storing a table of codes and correspondence to profile data on the private database.

50. The method of claim 48 wherein the code comprises at least one of:
a predetermined number of symbols including randomly selected numbers and letters;
a number representing a chronological order by which the authorized beneficiaries at least one of:
obtained a promise for access to the civil security resources;
became a member of an entity providing the civil security resources;
logged into the management system a first time;
submitted a profile to the management system;
a symbol representing a type of agreement an authorized beneficiary has with a provider of the civil security resources;
a symbol representing a location of the authorized beneficiary;
a symbol representing a type of civil security resource to be provided to an authorized beneficiary;
a symbol representing a way in which a civil security resource is to be provided to an authorized beneficiary.

51. The method of claim 1 wherein the profiles of the authorized beneficiaries comprise at least one of:
a legal name;
a nickname;
a general description including at least one of:
weight;
height;
physical attribute;
gender;
age;
hair color;
hair style;
skin color;
marks on the skin;
eye wear;
disability;
tattoo;
race;
nationality;
citizenship;
ancestry;
sexual orientation.

52. The method of claim 1 wherein the profiles of the authorized beneficiaries comprise at least one of:
an indication of other authorized beneficiaries relating to the authorized beneficiary of the profile;
a family member;
an heir;
an executor of an authorized beneficiary's estate;
a political agenda;
a group to which the authorized beneficiary belongs;
a pet;
an educational background;
a profession;
a financial condition;
a phone number;
an address;
a personal identification number.

53. The method of claim 1 wherein the profiles of the authorized beneficiaries comprise at least one of:
an authorized beneficiary's measured intelligence;
an authorized beneficiary's psychological test results;
an authorized beneficiary's behavioral test results;
health;
athletic ability;
mechanical ability;
skills;
medication being taken;
a medical condition;
a psychological condition;
a dietary preference a dietary restriction.

54. The method of claim 1 wherein the profiles of the authorized beneficiaries comprise at least one of:
a description of civil security resources accessible to the authorized beneficiary;
a reason an authorized beneficiary is denied access to a civil security resource;
a financial record relating to access to the civil security resources;
a preference relating to a civil security provision;
a preference relating to a civil security service;
a preference relating to a civil security facility.

55. The method of claim 1 wherein at least electronically isolating profiles of the authorized beneficiaries further comprises:
upon indication of at least an imminently threatened civilly-catastrophic event, establishing actions to be taken for non-profile required tasks in association with the civilly-catastrophic event;
electronically connecting a private database holding profile data of the authorized beneficiaries to the management system;
establishing actions to be taken based, at least in part, on the profile data of the authorized beneficiaries.

56. The method of claim 55 wherein at least electronically isolating profiles of the authorized beneficiaries further comprises at least one of:
activating an alert requesting the management system be at least electronically connected to the private database;
automatically electronically connecting the management system to the private database.

57. The method of claim 55 wherein at least electronically isolating profiles of the authorized beneficiaries further comprises:
detecting a stand-down event;
detaching the private database from the management system after indication of the stand-down event.

58. The method of claim 57 wherein the stand-down event is at least one of:
an announcement by authorities relating to a condition of a civilly-catastrophic event;
a conclusion based on threat assessment data relating to the civilly-catastrophic event;
a conclusion based on sensor data indicating an end of the civilly-catastrophic event;
a conclusion based on real-time observations indicating an end of the civilly-catastrophic event;
a conclusion based on a predicted end of the civilly-catastrophic event;
an indication of an imminent end of the civilly-catastrophic event;
an indication of an end of civil upheaval that is at least substantially caused by the civilly-catastrophic event.

59. A method comprising:
providing a plurality of private civil security resources comprising, at least in part:
civil security provisions;
civil security facilities; and
civil security services;
providing authorized beneficiaries with consideration-based access to the plurality of private civil security resources;
receiving profiles of authorized beneficiaries;
assigning one of a plurality of security clearance levels to personnel of at least one provider of the plurality of private civil security resources for restricting access to the profiles of authorized beneficiaries.

60. The method of claim 59 wherein the security clearance levels are assigned on a need-to-know basis.

61. The method of claim 59 wherein assigning one of a plurality of security clearance levels comprises providing personnel of the at least one provider that perform non-profile required tasks substantially no access to the profiles of authorized beneficiaries.

62. The method of claim 59 wherein assigning one of a plurality of security clearance levels comprises providing personnel of the at least one provider that perform tasks for a certain type of civil security resource only profile data of authorized beneficiaries related to the certain type of civil security resource.

63. The method of claim 59 wherein assigning one of a plurality of security clearance levels comprises providing only a code that uniquely relates to a given authorized beneficiary in lieu of other identifying information to facilitate particular profile-related tasks as carried out by the personnel.

64. The method of claim 63 wherein, when the particular profile-related tasks comprise at least one of:
delivering objects to authorized beneficiaries; and
transporting authorized beneficiaries;
further providing to the personnel addresses as correspond to the authorized beneficiaries.

65. The method of claim 63 wherein, when the particular profile-related tasks comprises at least stocking the private civil security provisions for an indicated authorized beneficiary, further providing to the personnel a list of provisions as correspond to the indicated authorized beneficiary.

66. The method of claim 63 wherein, when the particular profile-related tasks comprises at least maintaining the private civil security facilities, further providing to the personnel a facility-related preference list of the authorized beneficiaries.

67. The method of claim 63 wherein, when the particular profile-related tasks comprises identifying an indicated authorized beneficiary, further providing to the personnel identification information related to the indicated authorized beneficiary.

68. The method of claim 63 wherein, when the particular profile-related tasks relate to a particular authorized beneficiary for coordinating all civil security resources for the particular authorized beneficiary, further providing to the personnel all of the profile data only for the particular authorized beneficiaries assigned to the personnel.

69. The method of claim 63 wherein, when the particular profile-related tasks comprises coordination of a plurality of the civil security resources and multiple authorized beneficiaries, further comprises providing access to substantially all profile date of the authorized beneficiaries to the personnel.

70. The method of claim 59, further comprising:
providing access to data on an incident deployment and response system configured and arranged for managing the civil security resources, and wherein access is provided according to the security clearance level.

71. The method of claim 70, further comprising:
storing profile data of the authorized beneficiaries on a privacy module at least electronically detachable from the incident deployment and response system; and
providing access to the privacy module depending on the security clearance level.

72. An isolatable privacy module for detachable connection to an incident deployment and response system, the isolatable privacy module comprising:
a data storage device;
an interface configured and arranged for providing access to data on the data storage device and for being detachably connected to the incident deployment and response system; and
profiles stored on the data storage device and being of authorized beneficiaries of consideration-based and civilly-catastrophic event-based access to private civil security resources.

73. The isolatable privacy module of claim 72 further being configured and arranged so that a data security module restricts access to the profiles while the privacy module is connected to the incident deployment and response system.

74. The isolatable privacy module of claim 72 wherein a substantially sole purpose of the privacy module is to store data.

75. The isolatable privacy module of claim 72 further comprising at least one of:
a compact disc;
an optically-based memory;
a magneto-optically based memory;
a magnetically based memory;
a hard drive;
a memory drive selectively receiving the storage device;
a magnetic tape;
a thumb drive;
a solid-state memory;
a microchip;
an integrated-circuit based memory.

76. The isolatable privacy module of claim 72 being configured and arranged so that storing data is one of a plurality of purposes provided by the privacy module.

77. The isolatable privacy module of claim 72 further comprising at least one of:
a computer network having a plurality of computers being at least one of:
electronically; physically detachable from each other;
a mainframe computer;
a server;
a computer;
a laptop computer;
a portable computer;
a hand-held computer;
a personal data assistant;
a telephone having a memory for storing data;
an email transceiver device.

78. The isolatable privacy module of claim 77 wherein the isolatable privacy module is the computer network, and wherein the profiles are stored on a plurality of databases on at least two of the plurality of computers.

79. The isolatable privacy module of claim 72 wherein the incident deployment and response system further comprises at least one of:
a computer network;
a mainframe computer;
a server;
a computer;
a laptop computer;
a portable computer;
a hand-held computer;
a personal data assistant;
a telephone having a memory for storing data;
an email transceiver device.

80. The isolatable privacy module of claim 72, further comprising:
at least one interface, and wherein the incident deployment and response system has at least one interface, and wherein one interface of one of the privacy module and incident deployment and response system is a dock for receiving the interface on the other of the privacy module and the incident deployment and response system.

81. The isolatable privacy module of claim 72, further comprising an interface for forming a detachable connection with the incident deployment and response system having at least one of:
a plug connection;
a communication port;
a serial port;
a universal serial bus port;
a parallel port;
a line print terminal port;
a wireless connection;
an infrared-based connection;
a digital-signal based connection;
a digital-subscriber based connection;
a telephone-based connection;
a cellular network-based connection;
a satellite network-based connection;
a connection configured for being manually detached;
a connection detachable by a switch;
a connection detachable by operating a remote device wherein remote is relative to at least the connection and the management system.

82. An incident deployment and response system, comprising:
an interface for detachably electronically connecting to a private database storing profiles of authorized beneficiaries having consideration-based and civilly-catastrophic event-based access to at least one private civil security resource;
a non-private database configured for storing the profiles of authorized beneficiaries until the private database is accessible; and
a data security module for restricting access to the profiles of authorized beneficiaries.

83. The incident deployment and response system of claim 82 wherein the data security module is configured for restricting access to both the non-private database and the private database.

84. The incident deployment and response system of claim 82 wherein the data security module is configured for restricting access to the profiles based on a security clearance level of a user.

85. The incident deployment and response system of claim 82 where the data security module is configured for indicating to a user that the profiles reside on the non-private database.

86. The incident deployment and response system of claim 82 wherein the data security module is configured for indicating to a user that processes performed by the incident deployment and response system require access to the private database.

87. The incident deployment and response system of claim 82 wherein the data security module is configured for encrypting the profiles of authorized beneficiaries.

88. The incident deployment and response system of claim 82 wherein the data security module is configured for assigning a code corresponding to each authorized beneficiary and used for coordinating civil security resources accessible to the authorized beneficiary.

89. A management system, comprising:
at least one module configured for at least managing a plurality of private civil security resources comprising, at least in part:
civil security provisions;
civil security facilities; and
civil security services,
wherein the at least one module comprises at least one profile module configured for at least managing profiles of authorized beneficiaries with consideration-based access to the plurality of private civil security resources.

90. The management system of claim 89 wherein the at least one module has at least one of:
the same module managing both resources and profiles;
different modules managing resources and profiles.

91. The management system of claim 89 further comprising:
at least one security module configured for at least electronically isolating the profiles of the authorized beneficiaries from access by the management system at least while the management system is performing non-profile required tasks.

92. The management system of claim 91 wherein the at least one security module comprises at least one privacy module having a database for storing the profiles and being physically detachable from the management system.

93. The management system of claim 89 wherein the at least one module is configured to establish actions related to the private civil security resources based on information associated with a civilly-catastrophic event.
